(19) United States
(12) Patent Application Publication
(10) Pub. No.: US 2026/0023211 A1
(43) Pub. Date: Jan. 22, 2026

(54) OPTICAL FIBER WITH METAL AND POLYMER HYBRID COATING

(71) Applicant: CORNING INCORPORATED, Corning, NY (US)

(72) Inventors: Ming-Jun Li, Horseheads, NY (US); Wenchao Wang, Ithaca, NY (US)

(21) Appl. No.: 19/230,355

(22) Filed: Jun. 6, 2025

Related U.S. Application Data
(60) Provisional application No. 63/672,425, filed on Jul. 17, 2024.

(51) Int. Cl. G02B 6/02

(52) U.S. Cl. CPC G02B 6/02395

(57) ABSTRACT

An optical fiber may include a glass fiber having a core region and a cladding region surrounding the core region. The optical fiber may further include a hybrid coating surrounding the cladding region. The hybrid coating may include a polymer coating and a metal coating. The polymer coating may include a primary coating and a secondary coating surrounding the primary coating, and a Young's modulus of the secondary coating may be greater than the Young's modulus of the primary coating. The optical fiber with the hybrid coating may demonstrate robust mechanical and optical performance while achieving increased fiber density for high bandwidth applications.

This application claims the benefit of priority under 35 U.S.C. § 119 of U.S. Provisional Application Ser. No. 63/672,425 filed on Jul. 17, 2024, the content of which is relied upon and incorporated herein by reference in its entirety.

### FIELD

This disclosure pertains to optical fibers. More particularly, this disclosure pertains to optical fibers having a metal and polymer hybrid coating.

### BACKGROUND

Data center traffic has been growing exponentially due to the increased number of connected devices and new applications such as digitization of technologies and processes, remote working, over-the-top (OTT) media services, internet of things (IoT), machine learning (ML), and cloud computing. Hyper-scale data centers with millions of servers are being built to accommodate the bandwidth demand. To increase the capacity while reducing the footprint, high density optical interconnects are becoming a critical building component for data centers. One approach for increasing the bandwidth density is to increase the fiber density in a cable using reduced diameter fiber.

Optical fibers are generally produced with a polymer coating to protect the glass surface. Typically, a dual-layer coating system is used where a soft, inner-layer or primary coating is in contact with the glass fiber and a hard, outer-layer or secondary coating surrounds the inner-primary coating. The hard secondary coating provides mechanical protection to the fiber, allowing the fiber to be handled and further processed, while the soft primary coating provides a cushion in dissipating external forces and preventing them from being transferred to the fiber where they can cause microbending induced light attenuation. The standard optical fiber has a glass cladding in diameter of 125 μm. The outer diameter of the primary coating in the coated fiber is about 190 μm, and the outer diameter of the secondary coating in the coated fiber is about 250 μm. The fiber diameter can be reduced by decreasing the coating diameter. Fibers with the standard 125 μm glass diameter and reduced coating diameters of 190 μm to 200 μm have been commercially available for the past few years. Further reducing the coating diameter to below 190 μm with the standard glass diameter has been proposed. However, reducing coating diameter can result in less mechanical protection.

Accordingly, there is a need for fibers with reduced diameter while not compromising the mechanical properties.

### SUMMARY

Described herein are optical fibers having a hybrid coating incorporating both polymer and metal materials. In some embodiments, the optical fiber may include a thin metal coating which may provide improved mechanical protection and a polymer coating which may reduce microbending loss. Optical fibers with the metal and polymer hybrid coating may demonstrate robust mechanical and optical performance while achieving increased fiber density in a cable in applications where high bandwidth density may be needed.

In some embodiments, an optical fiber may include a glass fiber comprising a core region and a cladding region surrounding the core region. The optical fiber may further include a hybrid coating surrounding the cladding region. The hybrid coating may include a polymer coating comprising a primary coating, a secondary coating surrounding the primary coating, and a metal coating. A Young's modulus of the secondary coating may be greater than a Young's modulus of the primary coating.

In some embodiments, an optical fiber may include a glass fiber comprising a core region and a cladding region surrounding the core region. The optical fiber may further include a hybrid coating surrounding the cladding region. The hybrid coating may include a metal coating and a polymer coating. The metal coating may be disposed between the polymer coating and the cladding region.

Additional features and advantages will be set forth in the detailed description which follows, and in part will be readily apparent to those skilled in the art from the description or recognized by practicing the embodiments as described in the written description and claims hereof, as well as the appended drawings. It is to be understood that both the foregoing general description and the following detailed description are merely exemplary and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings are illustrative of selected aspects of the present disclosure, and together with the description serve to explain principles and operation of methods, products, and compositions embraced by the present disclosure.

FIG. 1 schematically illustrates a cross-sectional view of an exemplary optical fiber.

FIG. 2 schematically illustrates a cross-sectional view of an exemplary optical fiber ribbon.

FIG. 3 schematically illustrates a cross-sectional view of an exemplary optical fiber cable.

FIG. 4 schematically illustrates a cross-sectional view of an exemplary glass fiber.

FIG. 5 plots an exemplary relative refractive index profile of a glass fiber.

FIG. 6 schematically illustrates a cross-sectional view of an exemplary optical fiber having a hybrid coating.

FIG. 7 schematically illustrates a cross-sectional view of another exemplary optical fiber having a hybrid coating.

FIG. 8 schematically illustrates a cross-sectional view of another exemplary optical fiber having a hybrid coating.

FIG. 9 schematically illustrates a cross-sectional view of another exemplary optical fiber having a hybrid coating.

FIG. 10 schematically illustrates a cross-sectional view of another exemplary optical fiber having a hybrid coating.

FIGS. 11A and 11B are images of opposite end faces of an exemplary optical fiber segment with a hybrid coating.

FIGS. 12A and 12B are images of opposite end faces of another exemplary optical fiber segment with a hybrid coating.

### DETAILED DESCRIPTION

The present disclosure is provided as an enabling teaching and can be understood more readily by reference to the description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims which follow, “greater than or equal to” and “≥” are used interchangeably, “less than or equal to” and “≤” are used interchangeably, “greater than” and “>” are used interchangeably, and “less than” and “<” are used interchangeably. When a parameter is described as greater than or equal to (or simply, ≥) a value, the parameter may be greater than (>) the referenced value or equal to (=) the referenced value. Similarly, when a parameter is described as less than or equal to (or simply, ≤) a value, the parameter may be less than (<) the referenced value or equal to (=) the referenced value.

In this specification, and in the claims, which follow, reference will be made to a number of terms which shall be defined to have the following meanings:

“Optical fiber” refers to a waveguide having a glass portion surrounded by a coating. The glass portion includes a core and a cladding and is referred to herein as a “glass fiber”.

“Radial position”, “radius”, or the radial coordinate “r” refers to radial position relative to the centerline (r=0) of the fiber.

“Refractive index” refers to the refractive index at a wavelength of 1550 nm, unless otherwise specified.

The “refractive index profile” is the relationship between refractive index or relative refractive index and radius. For relative refractive index profiles depicted herein as having step boundaries between adjacent core and/or cladding regions, normal variations in processing conditions may preclude obtaining sharp step boundaries at the interface of adjacent regions. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position within the core region and/or any of the cladding regions. When relative refractive index varies with radial position in a particular region of the fiber (e.g. core region and/or any of the cladding regions), it is expressed in terms of its actual or approximate functional dependence, or its value at a particular position within the region, or in terms of an average value applicable to the region as a whole. Unless otherwise specified, if the relative refractive index of a region (e.g. core region and/or any of the cladding regions) is expressed as a single value or as a parameter (e.g. Δ or Δ%) applicable to the region as a whole, it is understood that the relative refractive index in the region is constant, or approximately constant, and corresponds to the single value, or that the single value or parameter represents an average value of a non-constant relative refractive index dependence with radial position in the region. For example, if “i” is a region of the glass fiber, the parameter Δᵢ refers to the average value of relative refractive index in the region as defined by Eq. (1) below, unless otherwise specified. Whether by design or a consequence of normal manufacturing variability, the dependence of relative refractive index on radial position may be sloped, curved, or otherwise non-constant.

“Relative refractive index,” as used herein, is defined in Eq. (1) as:

$${Δ}_{i} ( {r}_{i} ) \% = 100 \frac{( {n}_{i}^{2} - {n}_{r e f}^{2} )}{2 {n}_{i}^{2}} \qquad ( 1 )$$

where nᵢ is the refractive index at radial position rᵢ in the glass fiber, unless otherwise specified, and n_{ref} is the refractive index of pure silica glass, unless otherwise specified. Accordingly, as used herein, the relative refractive index percent is relative to pure silica glass, which has a value of 1.444 at a wavelength of 1550 nm. As used herein, the relative refractive index is represented by Δ (or “delta”) or Δ% (or “delta %) and its values are given in units of “%”, unless otherwise specified. Relative refractive index may also be expressed as Δ(r) or Δ(r) %.

The average relative refractive index (Δₐᵥₑ) of a region of the fiber is determined from Eq. (2):

$${Δ}_{ave} = {\int }_{{r}_{inner}}^{{r}_{outer}} \frac{Δ ( r ) dr}{( {r}_{outer} - {r}_{inner} )} \qquad ( 2 )$$

where rᵢₙₙₑᵣ is the inner radius of the region, rₒᵤₜₑᵣ is the outer radius of the region, and Δ(r) is the relative refractive index of the region.

The refractive index of an optical fiber profile may be measured using commercially available devices, such as the IFA-100 Fiber Index Profiler (Interfiber Analysis LLC, Sharon, MA USA) or the S14 Refractive Index Profiler (Photon Kinetics, Inc., Beaverton, OR USA). These devices measure the refractive index relative to a measurement reference index, n(r)−nₘₑₐₛ, where the measurement reference index nₘₑₐₛ is typically a calibrated index matching oil or pure silica glass. The measurement wavelength may be 632.5 nm, 654 nm, 677.2 nm, 654 nm, 702.3 nm, 729.6 nm, 759.2 nm, 791.3 nm, 826.3 nm, 864.1 nm, 905.2 nm, 949.6 nm, 997.7 nm, 1050 nm, or any wavelength therebetween. The absolute refractive index n(r) is then used to calculate the relative refractive index as defined by Eq. (1).

The term “α-profile” or “alpha profile” refers to a relative refractive index profile Δ(r) that has the functional form defined in Eq. (3):

$$Δ ( r ) = Δ ( {r}_{0} ) [ 1 - {[ \frac{\vert r - {r}_{0} \vert}{( {r}_{z} - {r}_{0} )} ]}^{α} ] \qquad ( 3 )$$

where rₒ is the radial position at which Δ(r) is maximum, Δ(r₀)>0, r_{z}>r₀ is the radial position at which Δ(r) decreases to its minimum value, and r is in the range rᵢ≤r≤r_{f}, where rᵢ is the initial radial position of the α-profile, r_{f} is the final radial position of the α-profile, and α is a real number. Δ(r₀) for an α-profile may be referred to herein as Δₘₐₓ or, when referring to a specific region i of the fiber, as Δᵢₘₐₓ. When the relative refractive index profile of the fiber core region is described by an α-profile with r₀ occurring at the centerline (r=0), r_{z} corresponding to the outer radius r₁of the core region, and Δ₁(r₁)=0, Eq. (3) simplifies to Eq. (4):

$${Δ}_{1} ( r ) = {Δ}_{1 max} [ 1 - {[ \frac{r}{{r}_{1}} ]}^{α} ] \qquad ( 4 )$$

When the core region has an index described by Eq. (4), the outer radius r₁ can be determined from the measured relative refractive index profile by the following procedure. Estimated values of the maximum relative refractive index Δ₁ₘₐₓ, α, and outer radius r₁ᵣₑₛₜ are obtained from inspection of the measured relative refractive index profile and used to create a trial function Δₜᵣᵢₐₗ between r=0 and r=r₁ₑₛₜ. The sum of the squares of the difference between the trial function and the measured profile (Δₘₑₐₛ), λ²=Σ(Δₜᵣᵢₐₗ−Δₘₑₐₛ)², is minimized over values of r ranging between 0.1 r₁ₑₛₜ and 0.95 r₁ₑₛₜ using the Nelder-Mead algorithm (Nelder, John A. and R. Mead, “A simplex method for function minimization,” Computer Journal 7: 308-313 (1965)) to determine Δ₁ₘₐₓ, α, and r₁.

“Trench volume” is defined as:

$${V}_{Trench} = \vert 2 {\int }_{{r}_{T r e nch , inner}}^{{r}_{T r e nch , outer}} {Δ}_{T r e n c h} ( r ) rdr \vert \qquad ( 5 )$$

where r_{Trench,inner} is the inner radius of the trench region of the refractive index profile, r_{Trench,outer} is the outer radius of the trench region of the refractive index profile, Δ_{Trench}(r) is the relative refractive index of the trench region of the refractive index profile, and r is radial position in the fiber. Trench volume is in absolute value and a positive quantity and will be expressed herein in units of % Δmicron², % Δ-micron², % Δ-μm², or % Δμm², whereby these units can be used interchangeably herein. A trench region is also referred to herein as a depressed-index cladding region and trench volume is also referred to herein as V₃.

The “mode field diameter” or “MFD” of an optical fiber is defined in Eq. (6) as:

$$\begin{matrix}MFD = 2 w \\ {w}^{2} = 2 \frac{{\int }_{0}^{∞} {( f ( r ) )}^{2} rdr}{{\int }_{0}^{∞} {( \frac{df ( r )}{dr} )}^{2} rdr}\end{matrix} \qquad ( 6 )$$

where f(r) is the transverse component of the electric field distribution of the guided optical signal and r is radial position in the fiber. “Mode field diameter” or “MFD” depends on the wavelength of the optical signal and is reported herein for wavelengths of 1310 nm, 1550 nm, and 1625 nm. Specific indication of the wavelength will be made when referring to mode field diameter herein. Unless otherwise specified, mode field diameter refers to the LP₀₁ mode at the specified wavelength.

“Effective area” of an optical fiber is defined in Eq. (7) as:

$${A}_{eff} = \frac{2 {π [ {\int }_{0}^{∞} {( f ( r ) )}^{2} rdr ]}^{2}}{{\int }_{0}^{∞} {( f ( r ) )}^{4} rdr} \qquad ( 7 )$$

where f(r) is the transverse component of the electric field of the guided optical signal and r is radial position in the fiber. “Effective area” or “A_{eff}” depends on the wavelength of the optical signal and is understood herein to refer to a wavelength of 1550 nm unless specified otherwise.

The term “attenuation,” as used herein, is the loss of optical power as the signal travels along the optical fiber. Attenuation was measured as specified by the IEC-60793-1-40 standard, “Attenuation measurement methods.”

The bend resistance of an optical fiber, expressed as “bend loss” herein, can be gauged by induced attenuation under prescribed test conditions as specified by the IEC-60793-1-47 standard, “Measurement methods and test procedures-Macrobending loss.” For example, the test condition can entail deploying or wrapping the fiber one or more turns around a mandrel of a prescribed diameter, e.g., by wrapping one turn around either a 15 mm, 20 mm, or 30 mm or similar diameter mandrel (e.g., “1×15 mm diameter bend loss” or the “1×20 mm diameter bend loss” or the “1×30 mm diameter bend loss”) and measuring the increase in attenuation per turn.

“Cable cutoff wavelength,” or “cable cutoff,” as used herein, refers to the 22 m cable cutoff test as specified by the IEC 60793-1-44 standard, “Measurement methods and test procedures—Cut-off wavelength.”

Reference will now be made in detail to illustrative embodiments of the present description.

### Optical Fiber

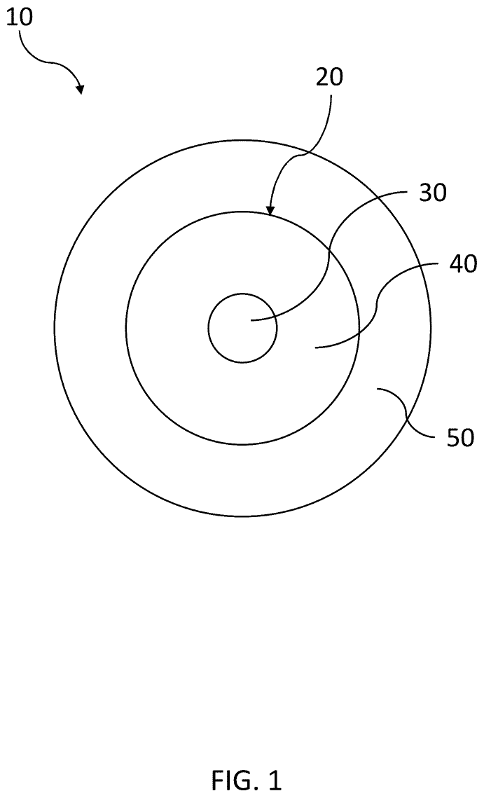

FIG. 1 schematically depicts an exemplary optical fiber 10 in cross-sectional view. The optical fiber 10 may include a glass fiber 20 and a coating 50 surrounding and directly contacting the glass fiber 20. The glass fiber 20 may include a core region 30 and a cladding region 40 surrounding and directly contacting the core region 30. The core region 30 may have a higher refractive index than the cladding region 40, and the glass fiber 20 functions as a waveguide. In some embodiments, the core region 30 and the cladding region 40 may have a discernible core-cladding boundary. Alternatively, the core region 30 and the cladding region 40 may lack a distinct boundary. The coating 50 may include a metal and polymer hybrid coating, as will be discussed in more detail below.

### Ribbon and Cable

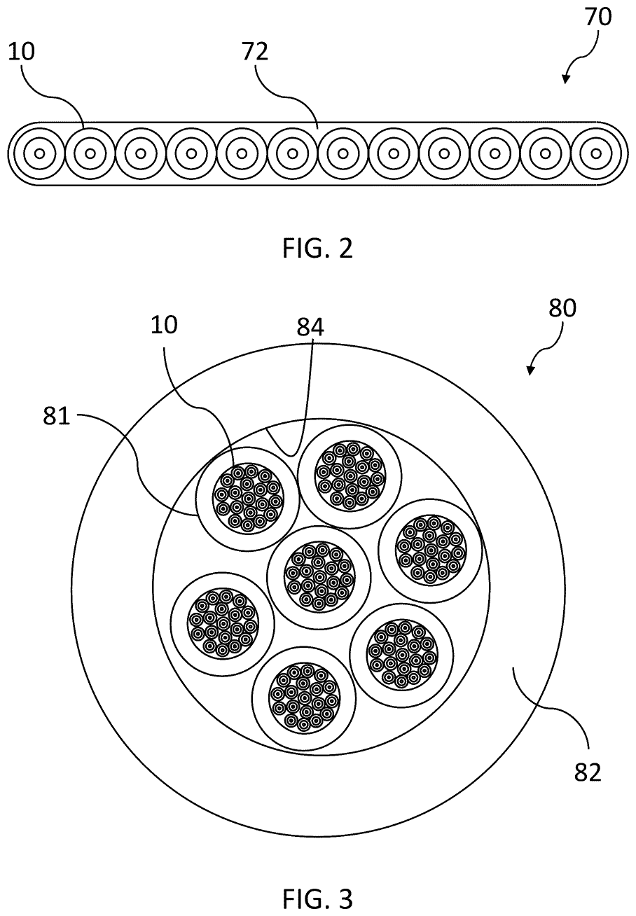

FIG. 2 illustrates an optical fiber ribbon 70, which may include a plurality of optical fibers 10 and a matrix 72 encapsulating the plurality of optical fibers 10. As shown, the optical fibers 10 may be aligned relative to one another in a substantially planar and parallel relationship. The optical fibers 10 in the fiber optic ribbon 70 may be encapsulated by the ribbon matrix 72 in any of several configurations (e.g., edge-bonded ribbon, thin-encapsulated ribbon, thick-encapsulated ribbon, or multi-layer ribbon) by methods of making fiber optic ribbons. The fiber optic ribbon 70 in the embodiment of FIG. 2 contains twelve (12) optical fibers 10. However, it is contemplated that any number of the optical fibers 10 (e.g., two or more, four more, six or more, 8 or more, 12 or more, or 16 or more) may be employed to form the fiber optic ribbon 70 for a particular use. The ribbon matrix 72 may have tensile properties similar to the tensile properties of a high-modulus coating and can be formed from the same, similar, or different composition used to prepare a high-modulus coating.

FIG. 3 illustrates an optical fiber cable 80 that includes two or more tubes 81 each having a plurality of optical fibers 10 that may be densely or loosely packed therein. The tubes 81 may be densely or loosely packed into a conduit enclosed by an inner surface 84 of a jacket 82 of the optical fiber cable 80. In some embodiments, the optical fiber cable 80 may include multiple optical fiber ribbons (not shown) packed inside the tubes 81 and/or the jacket 82. In some embodiments, the optical fiber cable 80 is a submarine cable. In some embodiments, the optical fiber cable 80 is used in interconnection schemes within a data center. The number of fibers placed in the jacket 82 is referred to as the “fiber count” of the optical fiber cable 80. As discussed further below, the optical fibers of the present disclosure have a reduced diameter, thus providing a high “fiber count.”

The jacket 82 is formed from an extruded polymer material and may include multiple concentric layers of polymers or other materials. Optical fiber cable 80 may include one or more strengthening members (not shown) embedded within jacket 82 or placed within the conduit defined by inner surface 84. Strengthening members include fibers or rods that are more rigid than jacket 82. The strengthening member may be made from metal, braided steel, glass-reinforced plastic, fiber glass, or other suitable material. Optical fiber cable 80 may include other layers surrounded by jacket 82 such as, for example, armor layers, moisture barrier layers, rip cords, etc. Furthermore, optical fiber cable 80 may have a stranded, loose tube core or other fiber optic cable construction.

### Glass Fiber

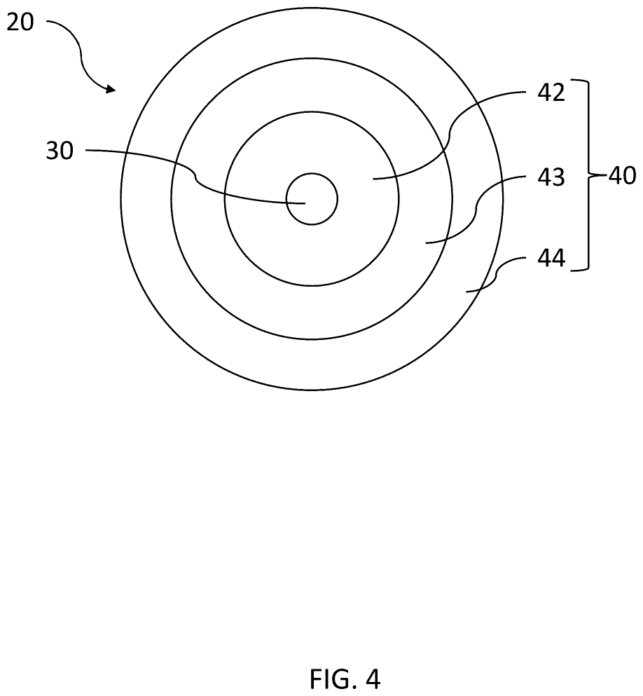

FIG. 4 schematically depicts an example of the glass fiber 20 in cross-sectional view that may be used with embodiments described herein. In some embodiments, the cladding region 40 may include an inner cladding region 42, a depressed-index cladding region or trench region 43, and an outer cladding region 44. The depressed-index cladding region 43 may contribute to a reduction in bending losses and microbending sensitivity.

As shown in FIG. 4, the inner cladding region 42 may surround and may be directly adjacent to the core region 30. The depressed-index cladding region 43 may surround and may be directly adjacent to the inner cladding region 42 such that the depressed-index cladding region 43 may be disposed between the inner cladding 42 and the outer cladding 44 in a radial direction. The outer cladding region 44 may surround and may be directly adjacent to the depressed-index cladding region 43. The core region 30 may be substantially cylindrical in shape, and the surrounding inner cladding region 42, depressed-index cladding region 43, and outer cladding region 44 may be substantially annular in shape. The cylindrical core region 30, the annular inner cladding region 42, the annular depressed-index cladding region 43, and the annular outer cladding region 44 may be concentric. While FIG. 4 depicts a schematic cross-sectional depiction of one exemplary glass fiber, other suitable glass fibers may be used with embodiments described herein.

In some embodiments, the relative refractive index may be constant or approximately constant over a region. In some embodiments, the relative refractive index may vary and may include a maximum value Δₘₐₓ and a minimum value Δₘᵢₙ within a region. Unless otherwise specified, if a single value is reported for the relative refractive index of a region, the single value corresponds to an average value for the region.

As will be described further hereinbelow, the core region 30, the inner cladding region 42, the depressed-index cladding region 43, and/or the outer cladding region 44 may be formed from doped or undoped silica glass. Variations in refractive index relative to undoped silica glass are accomplished by incorporating updopants or downdopants at levels designed to provide a targeted refractive index or refractive index profile. Updopants are dopants that increase the refractive index of the glass relative to the undoped glass composition. Downdopants are dopants that decrease the refractive index of the glass relative to the undoped glass composition. In some embodiments, the undoped glass is silica glass. When the undoped glass is silica glass, updopants include Cl, Br, Ge, Al, P, Ti, Zr, Nb, and Ta, and downdopants include Fluorine and Boron. Regions of constant refractive index may be formed by not doping or by doping at a uniform concentration over the thickness of the region. Regions of variable refractive index are formed through non-uniform spatial distributions of dopants over the thickness of a region and/or through incorporation of different dopants in different regions.

### Exemplary Refractive Index Profile Designs for Single Mode Fiber

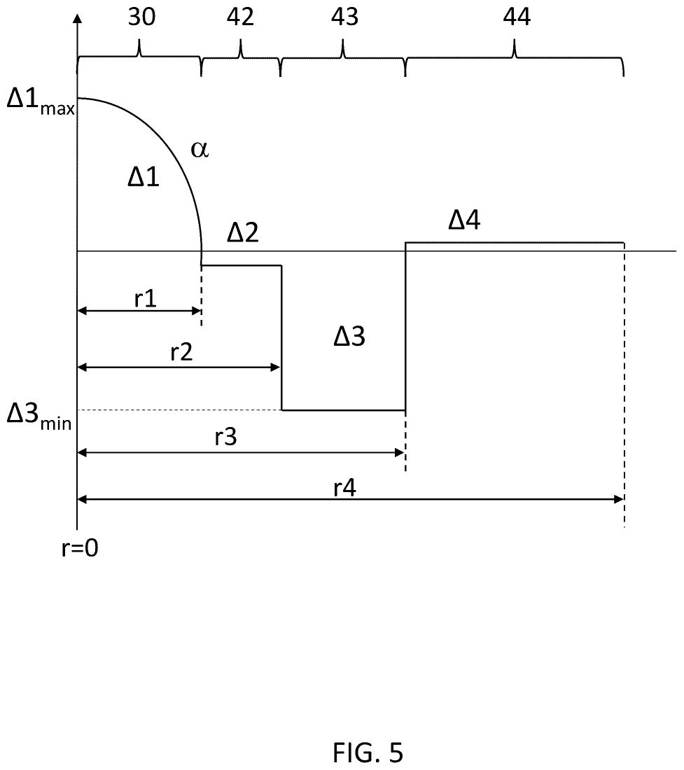

FIG. 5 plots an idealized relative refractive index profile of an example of the glass fiber 20 that may be single mode and used with embodiments described herein. The core region 30 has relative refractive index Δ₁, with a maximum refractive index of Δ₁ₘₐₓ at r=0. The inner cladding region 42 has a relative refractive index Δ₂. The depressed-index cladding region 43 has a relative refractive index Δ₃, with a minimum refractive index Δ₃ₘᵢₙ. The outer cladding region 44 has a relative refractive index Δ₄. In some embodiments, Δ₃ₘᵢₙ<Δ₂ and Δ₃ₘᵢₙ<Δ₄. In some embodiments, Δ₁>Δ₂>Δ₃ and Δ₄>Δ₃. The values of Δ₂ and Δ₄ may be equal or either may be greater than the other, but both Δ₂ and Δ₄ are between Δ₁ₘₐₓ and Δ₃. Other configurations for the relative refractive index profile are contemplated.

### Core Region

The core region 30 may include silica glass that may be either un-doped silica glass, up-doped silica glass, and/or down-doped silica glass. Up-doped silica glass may include silica glass doped with, for example, germanium (e.g., GeO₂), phosphorus (e.g., P₂O₅), aluminum (e.g., Al₂O₃), chlorine, or an alkali metal oxide (e.g., Na₂O, K₂O, Li₂O, Cs₂O, or Rb₂O). In some embodiments, the core may include germanium doped glass having a germanium concentration between about 4 wt. % and about 8 wt. %. In embodiments where the core may be doped with an alkali dopant, the peak concentration of the alkali in the silica glass may range from about 10 ppm to about 500 ppm, or from about 30 ppm to about 400 ppm. In yet other embodiments, the silica glass of the core region 30 may be free of germanium and/or chlorine; that is the core region may include silica glass that lacks germanium and/or chlorine. Down-doped silica glass may include silica glass doped with, for example, fluorine or boron.

In some embodiments, the core region 30 may include a radius r₁ that may be greater than or equal to (i.e., ≥) 3 μm and less than or equal to (i.e., ≤) 6 μm—including all sub-ranges or values therebetween. For example, in some embodiments, the radius r₁ of the core region 30 may be ≥3 μm and ≤6 μm, ≥3 μm and ≤5.5 μm, ≥3 μm and ≤5 μm, ≥3 μm and ≤4.5 μm, ≥3 μm and ≤4 μm, ≥3 μm and ≤3.5 μm, ≥3.5 μm and ≤6 μm, ≥3.5 μm and ≤5.5 μm, ≥3.5 μm and ≤5 μm, ≥3.5 μm and ≤4.5 μm, ≥3.5 μm and ≤4 μm, ≥4 μm and ≤6 μm, ≥4 μm and ≤5.5 μm, ≥4 μm and ≤5 μm, ≥4 μm and ≤4.5 μm, ≥4.5 μm and ≤6 μm, ≥4.5 μm and ≤5.5 μm, ≥4.5 μm and ≤5 μm, ≥5 μm and ≤6 μm, ≥5 μm and ≤5.5 μm, or ≥5.5 μm and ≤6 μm. In some embodiments, the radius r₁ of the core region 30 may be greater than or equal to (i.e., ≥) 3 μm, ≥3.5 μm, ≥4 μm, ≥4.5 μm, ≥5 μm, ≥5.5 μm, or greater. In some embodiments, the radius r₁ of the core region 30 may be less than or equal to (i.e., ≤) 6 μm, ≤5.5 μm, ≤5 μm, ≤4.5 μm, ≤4 μm, ≤3.5 μm, or less.

The core region 30 may include a step index profile with an α value greater than or equal to 10 or a graded index profile with an α value less than 10. In some embodiments, the α value may be greater than or equal to (i.e., ≥) 2 and less than or equal to (i.e., ≤) 20—including all sub-ranges or values therebetween. For example, in some embodiments, the α value may be ≥2 and ≤20, ≥2 and ≤18, ≥2 and ≤16, ≥2 and ≤14, ≥2 and ≤12, ≥2 and ≤10, ≥2 and ≤8, ≥2 and ≤6, ≥6 and ≤20, ≥6 and ≤18, ≥6 and ≤16, ≥6 and ≤14, ≥6 and ≤12, ≥6 and ≤10, ≥6 and ≤8, ≥8 and ≤20, ≥8 and ≤18, ≥8 and ≤16, ≥8 and ≤14, ≥8 and ≤12, ≥8 and ≤10, ≥10 and ≤20, ≥10 and ≤18, ≥10 and ≤16, ≥10 and ≤14, ≥10 and ≤12, ≥12 and ≤20, ≥12 and ≤18, ≥12 and ≤16, ≥12 and ≤14, ≥14 and ≤20, ≥14 and ≤18, ≥14 and ≤16, ≥16 and ≤20, ≥16 and ≤18, or ≥18 and ≤20. In some embodiments, the α value may be less than or equal to (i.e., ≤) 20, ≤19, ≤18, ≤17, ≤16, ≤15, ≤14, ≤13, ≤12, ≤11, ≤10, ≤9, ≤8, ≤7, ≤6, ≤5, ≤4, ≤3, or less. In some embodiments, the α value may be greater than or equal to (i.e., ≥) 2, ≥3, 4, ≥5, ≥6, ≥7, ≥8, ≥9, ≥10, ≥11, ≥12, ≥13, ≥14, ≥15, ≥16, ≥17, ≥18, ≥19, or greater.

In some embodiments, the maximum relative refractive index Δ₁ₘₐₓ of the core region 30 relative to the outer cladding region 44 may be greater than or equal to (i.e., ≥) 0.3% and less than or equal to (i.e., ≤) 0.5%—including all sub-ranges or values therebetween. For example, in some embodiments, the maximum relative refractive index Δ₁ₘₐₓ of the core region 30 may be ≥0.3% and ≤0.5%, ≥0.3% and ≤0.45%, ≥0.3% and ≤0.4%, ≥0.3% and ≤0.35%, ≥0.35% and ≤0.5%, ≥0.35% and ≤0.45%, ≥0.35% and ≤0.4%, ≥0.4% and ≤0.5%, ≥0.4% and ≤0.45%, or ≥0.45% and ≤0.5%. In some embodiments, the maximum relative refractive index Δ₁ₘₐₓ of the core region 30 may be greater than or equal to (i.e., ≥) 0.3%, ≥0.32%, ≥0.34%, ≥0.36%, ≥0.38%, ≥0.4%, ≥0.42%, ≥0.44%, ≥0.46%, ≥0.48%, or greater. In some embodiments, the maximum relative refractive index Δ₀ and Δ₁ₘₐₓ of the core region 30 may be less than or equal to (i.e., ≤) 0.5%, ≤0.49%, ≤0.47%, ≤0.45%, ≤0.43%, ≤0.41%, ≤0.4%, ≤0.39%, ≤0.37%, ≤0.35%, ≤0.33%, ≤0.31%, or less.

Although not depicted, in some embodiments, the relative refractive index of the core region 30 may have a centerline dip such that the maximum refractive index of the core region 30 and the maximum refractive index of the entire optical fiber 10 may be located a small distance away from the centerline of the core region 30 rather than at the centerline of the core region 30 as depicted in FIG. 5.

### Inner Cladding Region

In some embodiments, the inner cladding region 42 may include un-doped silica glass. In some embodiments, the inner cladding region 42 may include up-doped silica glass and/or down-doped silica glass, doped with any of the up-dopant and/or down-dopant described above to increase and/or decrease its index.

The relative refractive index Δ₂ of the inner cladding region 42 may be greater than or equal to (i.e., ≥) 31 0.20% and less than or equal to (i.e., ≤) 0.10%—including all sub-ranges or values therebetween. For example, in some embodiments, the relative refractive index Δ₂ of the inner cladding region 42 may be ≥−0.20% and ≤0.10%, ≥−0.10% and ≤0.10%, ≥−0.05% and ≤0.10%, or ≥−0.05% and ≤0.05%. In some embodiments, the relative refractive index Δ₂ of the inner cladding region 42 may be greater than or equal to (i.e., ≥) −0.20%, ≥−0.15%, ≥−0.10%, ≥−0.05%, ≥0%, ≥0.05%, or greater. In some embodiments, the relative refractive index Δ₂ of the inner cladding region 42 may be less than or equal to (i.e., ≤) 0.10%, ≤0.05%, ≤0%, ≤−0.05%, ≤−0.10%, or less. In some embodiments, the relative refractive index Δ₂ may be about 0.0%. The relative refractive index Δ₂ may be preferably constant or approximately constant.

The inner cladding region 42 may include an inner radius r₁ corresponding to the outer radius r₁ of the core region 30, as discussed above. The inner cladding region 42 may include an outer radius r₂ that may be greater than or equal to (i.e., ≥) 3 μm and less than or equal to (i.e., ≤) 14 μm—including all sub-ranges or values therebetween. For example, in some embodiments, the outer radius r₂ of the inner cladding region 42 may be ≥3 μm and ≤14 μm, ≥3 μm and ≤13 μm, ≥3 μm and ≤12 μm, ≥3 μm and ≤11 μm, ≥3 μm and ≤10 μm, ≥3 μm and ≤9 μm, ≥3 μm and ≤8 μm, ≥3 μm and ≤7 μm, ≥3 μm and ≤6 μm, ≥3 μm and ≤5 μm, ≥3 μm and ≤4 μm, ≥4 μm and ≤14 μm, ≥4 μm and ≤13 μm, ≥4 μm and ≤12 μm, ≥4 μm and ≤11 μm, ≥4 μm and ≤10 μm, ≥4 μm and ≤9 μm, ≥4 μm and ≤8 μm, ≥4 μm and ≤7 μm, ≥4 μm and ≤6 μm, ≥4 μm and ≤5 μm, ≥5 μm and ≤14 μm, ≥5 μm and ≤13 μm, ≥5 μm and ≤12 μm, ≥5 μm and ≤11 μm, ≥5 μm and ≤10 μm, ≥5 μm and ≤9 μm, ≥5 μm and ≤8 μm, ≥5 μm and ≤7 μm, ≥5 μm and ≤6 μm, ≥6 μm and ≤14 μm, ≥6 μm and ≤13 μm, ≥6 μm and ≤12 μm, ≥6 μm and ≤11 μm, ≥6 μm and ≤10 μm, ≥6 μm and ≤9 μm, ≥6 μm and ≤8 μm, ≥6 μm and ≤7 μm, ≥7 μm and ≤14 μm, ≥7 μm and ≤13 μm, ≥7 μm and ≤12 μm, ≥7 μm and ≤11 μm, ≥7 μm and ≤10 μm, ≥7 μm and ≤9 μm, ≥7 μm and ≤8 μm, ≥8 μm and ≤14 μm, ≥8 μm and ≤13 μm, ≥8 μm and ≤12 μm, ≥8 μm and ≤11 μm, ≥8 μm and ≤10 μm, ≥8 μm and ≤9 μm, ≥9 μm and ≤14 μm, ≥9 μm and ≤13 μm, ≥9 μm and ≤12 μm, ≥9 μm and ≤11 μm, ≥9 μm and ≤10 μm, ≥10 μm and ≤14 μm, ≥10 μm and ≤13 μm, ≥10 μm and ≤12 μm, ≥10 μm and ≤11 μm, ≥11 μm and ≤14 μm, ≥11 μm and ≤13 μm, ≥11 μm and ≤12 μm, ≥12 μm and ≤14 μm, ≥12 and ≤13 μm, or ≥13 and ≤14 μm.

In some embodiments, the outer radius r₂ of the inner cladding region 42 may be greater than or equal to (i.e., ≥) 3 μm, ≥3.5 μm, ≥4 μm, ≥5 μm, ≥5.5 μm, ≥6 μm, ≥6.5μm, ≥7 μm, ≥7.5 μm, ≥8 μm, ≥8.5 μm, ≥9 μm, ≥9.5 μm, ≥10 μm, ≥10.5 μm, ≥11 μm, ≥11.5 μm, ≥12 μm, ≥12.5 μm, ≥13 μm, ≥13.5 μm, or greater. In some embodiments, the outer radius r₂ of the inner cladding region 42 may be less than or equal to (i.e., ≤) 14 μm, ≤13.5 μm, ≤13 μm, ≤12.5 μm, ≤12 μm, ≤11.5 μm, ≤11 μm, ≤10.5 μm, ≤10 μm, ≤9.5 μm, ≤9 μm, ≤8.5 μm, ≤8 μm, ≤7.5 μm, ≤7 μm, ≤6.5 μm, ≤6 μm, ≤5.5 μm, ≤5 μm, ≤4.5 μm, ≤4 μm, ≤3.5 μm, or less.

The thickness of the inner cladding region 42 as defined by the difference between the radial position r₂ and the radial position r₁, i.e., r₂−r₁, may be greater than or equal to (i.e., ≥) 1 μm and less than or equal to (i.e., ≤) 10 μm—including all sub-ranges or values therebetween. For example, in some embodiments, the thickness of the inner cladding region 42, r₂−r₁, may be ≥1 μm and ≤10 μm, ≥1 μm and ≤8 μm, ≥1 μm and ≤6 μm, ≥1 μm and ≤4 μm, ≥1 μm and ≤2 μm, ≥3 μm and ≤10 μm, ≥3 μm and ≤8 μm, ≥3 μm and ≤6 μm, ≥3 μm and ≤4 μm, ≥5 μm and ≤10 μm, ≥5 μm and ≤8 μm, ≥5 μm and ≤6 μm, ≥7 μm and ≤10 μm, ≥7 μm and ≤8 μm, or ≥9 μm and ≤10 μm. In some embodiments, the thickness of the inner cladding region 42, r₂−r₁, may be greater than or equal to (i.e., ≥) 1 μm, ≥2 μm, ≥3 μm, ≥4 μm, ≥5 μm, ≥6 μm, ≥7 μm, ≥8 μm, ≥9 μm, or greater. In some embodiments, the thickness of the inner cladding region 42, r₂−r₁, may be less than or equal to (i.e., ≤) 10μm, ≤9 μm, ≤8 μm, ≤7 μm, ≤6 μm, ≤5 μm, ≤4 μm, ≤3 μm, ≤2 μm, or less.

While FIGS. 4 and 5 illustrate exemplary embodiments having an offset trench design with the inner cladding region 42 disposed between the core region 30 and the depressed-index cladding region 43, in some embodiments, the glass fiber 20 may not include the inner cladding region 42. In some embodiments, the depressed-index cladding region 43 may be directly adjacent to or contact the core region 30, and the radius r₁ of the core region 30 may correspond to the inner radius of the depressed-index cladding region 43.

### Depressed-Index Cladding Region

The depressed-index cladding region 43 may include down-doped silica glass. In some embodiments, the depressed-index cladding region 43 may be down-doped with fluorine or boron. However, the down-doping of the depressed-index cladding region 43 may also be accomplished by incorporating voids in silica glass.

In some embodiments, the minimum relative refractive index Δ₃ₘᵢₙ of the depressed-index cladding region 43 may be greater than or equal to (i.e., ≥) −0.7% and less than or equal to (i.e., ≤) −0.2%—including all sub-ranges or values therebetween. For example, in some embodiments, the minimum relative refractive index Δ₃ₘᵢₙ may be ≥−0.7% and ≤−0.2%, ≥−0.7% and ≤−0.4%, ≥−0.7% and ≤−0.6%, ≥−0.5% and ≤−0.2%, ≥−0.5% and ≤−0.4%, or ≥−0.3% and ≤−0.2%. In some embodiments, the minimum relative refractive index Δ₃ₘᵢₙ may be greater than or equal to (i.e., ≥) −0.7%, ≥−0.65%, ≥−0.6%, ≥−0.55%, ≥−0.5%, ≥−0.45%, ≥−0.4%, ≥−0.35%, ≥−0.3%, ≥−0.25%, or greater. In some embodiments, the minimum relative refractive index Δ₃ₘᵢₙ may be less than or equal to (i.e., ≤) −0.2%, ≤−0.25%, ≤−0.3%, ≤−0.35%, ≤−0.4%, ≤−0.45%, ≤−0.5%, ≤−0.55%, ≤−0.6%, ≤−0.65%, or less.

The depressed-index cladding region 43 may include an inner radius r₂ corresponding to the outer radius r₂ of the inner cladding region 42, as discussed above. The depressed-index cladding region 43 may include an outer radius r₃ that may be greater than or equal to (i.e., ≥) 6 μm and less than or equal to (i.e., ≤) 20 μm—including all sub-ranges or values therebetween. For example, in some embodiments, the outer radius r₃ of the depressed-index cladding region 43 may be ≥6 μm and ≤20 μm, ≥6 μm and ≤18 μm, ≥6 μm and ≤16 μm, ≥6 μm and ≤14 μm, ≥6 μm and ≤12 μm, ≥6 μm and ≤10 μm, 6 μm and ≤8 μm, ≥8 μm and ≤20 μm, ≥8 μm and ≤18 μm, ≥8 μm and ≤16 μm, ≥8 μm and ≤14 μm, ≥8 μm and ≤12 μm, ≥8 μm and ≤10 μm, ≥10 μm and ≤20 μm, ≥10 μm and ≤18 μm, ≥10 μm and ≤16 μm, ≥10 μm and ≤14 μm, ≥10 μm and ≤12 μm, ≥12 μm and ≤20 μm, ≥12 μm and ≤18 μm, ≥12 μm and ≤16 μm, ≥12 μm and ≤14 μm, ≥14 μm and ≤20 μm, ≥14 μm and ≤18 μm, ≥14 μm and ≤16 μm, ≥16 μm and ≤20 μm, ≥16 μm and ≤18 μm, or ≥18 μm and ≤20 μm. In some embodiments, the outer radius r₃ of the depressed-index cladding region 43 may be greater than or equal to (i.e., ≥) 6 μm, ≥6.5 μm, ≥7 μm, ≥7.5 μm, ≥8 μm, ≥8.5 μm, ≥9 μm, ≥9.5 μm, ≥10 μm, ≥10.5 μm, ≥11 μm, ≥11.5 μm, ≥12 μm, ≥12.5 μm, ≥13 μm, ≥13.5 μm, ≥14 μm, ≥14.5 μm, ≥15 μm, ≥15.5 μm, ≥16 μm, ≥16.5 μm, ≥17 μm, ≥17.5 μm, ≥18 μm, ≥18.5 μm, ≥19 μm, ≥19.5 μm, or greater. In some embodiments, the outer radius r₃ of the depressed-index cladding region 43 may be less than or equal to (i.e., ≤) 20 μm, ≤19.5 μm, ≤19 μm, ≤18.5 μm, ≤18 μm, ≤17.5 μm, ≤17 μm, ≤16.5 μm, ≤16 μm, ≤15.5 μm, ≤15 μm, ≤14.5 μm, ≤14 μm, ≤13.5 μm, ≤13 μm, ≤12.5 μm, ≤12 μm, ≤11.5μm, ≤11 μm, ≤10.5 μm, ≤10 μm, ≤9.5 μm, ≤9 μm, ≤8.5 μm, ≤8 μm, ≤7.5 μm, ≤7 μm, ≤6.5 μm, or less.

In some embodiments, the depressed-index cladding region 43 may include a trench design. The width of the depressed-index cladding region 43 or the width of the trench, as defined by the difference between the radial position r₂ and the radial position r₃, i.e., r₃−r₂, may be greater than or equal to (i.e., ≥) 3 μm and less than or equal to (i.e., ≤) 8 μm—including all sub-ranges or values therebetween. For example, in some embodiments, the width of the depressed-index cladding region 43 may be ≥3 μm and ≤8 μm, ≥3 μm and ≤6 μm, ≥3 μm and ≤4 μm, ≥5 μm and ≤8 μm, ≥5 μm and ≤6 μm, or ≥7 μm and ≤8 μm. In some embodiments, the width of the depressed-index cladding region 43 may be greater than or equal to (i.e., ≥) 3 μm, ≥4 μm, ≥5 μm, ≥6 μm, ≥7 μm, or greater. In some embodiments, the width of the depressed-index cladding region 43 may be less than or equal to (i.e., ≤) 8 μm, ≤7 μm, ≤6 μm, ≤5 μm, ≤4 μm, or less.

### Outer Cladding Region

In some embodiments, the outer cladding region 44 may include un-doped silica glass. In some embodiments, the outer cladding region 44 may include up-doped silica glass and/or down-doped silica glass, doped with any of the up-dopant and/or down-dopant described above to increase and/or decrease its index. The relative refractive index Δ₄ of the outer cladding region 44 may be greater than or equal to (i.e., ≥) −0.10% and less than or equal to (i.e., ≤) 0.10%—including all sub-ranges or values therebetween. For example, in some embodiments, the relative refractive index Δ₄ of the outer cladding region 44 may be ≥−0.10% and ≤0.10%, or ≥−0.05% and ≤0.05%. In some embodiments, the relative refractive index Δ₄ of the outer cladding region 44 may be greater than or equal to (i.e., ≥) −0.10%, ≥−0.05%, or greater. In some embodiments, the relative refractive index Δ₄ of the outer cladding region 44 may be less than or equal to (i.e., ≤) 0.10%, ≤0.05%, or less. In some embodiments, the relative refractive index Δ₄ is about 0.0%. The relative refractive index Δ₄ is preferably constant or approximately constant.

An inner radius r₃ of the outer cladding region 44 may correspond to the outer radius r₃ of the depressed-index cladding region 43, as discussed above. An outer radius r₄ of the outer cladding region 44 and/or an outer radius r₄ of the glass fiber 20 when the outer cladding region 44 is the outermost glass layer of the glass fiber 20, may be greater than or equal to (i.e., ≥) 30 μm and less than or equal to (i.e., ≤) 65 μm—including all sub-ranges or values therebetween. For example, in some embodiments, the outer radius r₄ of the outer cladding region 44 and/or the outer radius r₄ of the glass fiber 20 may be ≥40 μm and ≤65 μm, ≥60 μm and ≤65 μm, or about 62.5 μm.

Table 1 below shows further exemplary fiber profile designs that may be used with embodiments described herein and various optical properties of the exemplary fiber profile designs.

TABLE 1

| | Ex. 1 | Ex. 2 | Ex. 3 | Ex. 4 | Ex. 5 | Ex. 6 |
|---|---|---|---|---|---|---|
| Core delta Δ₁ (%) | 0.34 | 0.29 | 0.405 | 0.34 | 0 | 0 |
| Core alpha | 20 | 20 | 2.4 | 20 | 20 | 20 |
| Core radius r₁ (μm) | 4.5 | 4.35 | 5.9 | 4.05 | 4.9 | 5.9 |
| Inner cladding delta Δ₂ (%) | na | −0.08 | 0 | 0 | −0.4 | −0.3 |
| Inner cladding radius r₂ (μm) | na | 12 | 10 | 9.8 | 20 | 22 |
| Trench delta Δ₃ (%) | na | na | na | −0.4 | na | na |
| Trench radius r₃ (μm) | na | na | na | 16 | na | na |
| Outer cladding delta Δ₄ (%) | 0 | 0 | 0.05 | 0 | −0.3 | −0.2 |
| Cable cutoff (nm) | 1208 | 1205 | 1196 | 1210 | 1405 | 1472 |
| MFD at 1310 nm (μm) | 9.2 | 8.8 | 9.2 | 8.8 | 9.1 | 10.7 |
| A_{eff} at 1310 nm (μm²) | 66.7 | 61.9 | 65.1 | 60.6 | 67.6 | 94.5 |
| Dispersion at 1310 nm (ps/nm · km) | 0.33 | 0.31 | −0.10 | −0.25 | 3.17 | 3.57 |
| Dispersion slope at 1310 nm (ps/nm² · km) | 0.0862 | 0.0844 | 0.0884 | 0.0896 | 0.0855 | 0.0878 |
| MFD at 1550 nm (μm) | 10.4 | 10.0 | 10.5 | 10.0 | 10.1 | 11.8 |
| A_{eff} at 1550 nm (μm²) | 83.1 | 77.4 | 82.6 | 75.8 | 80.1 | 110.8 |
| Dispersion at 1550 nm (ps/nm · km) | 17.0 | 16.3 | 16.9 | 17.7 | 19.8 | 20.7 |
| Dispersion slope at 1550 nm (ps/nm² · km) | 0.0577 | 0.0533 | 0.0579 | 0.0645 | 0.0575 | 0.0597 |

Example 1 is a fiber with a step index profile design, which may be made with Ge-doped core and pure silica cladding. The fiber of example 1 exhibits a 1550 nm bending loss less than 0.05 dB/turn at 30 mm mandrel diameter. The bending loss is further improved by using a depressed-index cladding, such as in the case of example 2. In example 2, the core includes a step index profile and can be made using Ge-doped glass, the inner cladding can be made with F-doped glass, and the outer cladding can be pure silica. Example 3 is a fiber similar to the fiber of example 2 but includes a Ge-doped graded index core, a pure silica inner cladding, and a Ge-dope outer cladding. Both example 2 and example 3 have a 1550 nm bending loss less than 0.005 dB/turn at 30 mm mandrel diameter, and less than 0.5 dB/turn at mandrel diameter of 20 mm. Example 4 is a fiber with a step index core and a low index trench in the cladding to further reduce the bending loss. The fiber of example 4 can be made with a Ge-doped core, a pure silica inner cladding, a F-doped low index trench, and a pure silica outer cladding. The fiber of example 4 exhibits even better bending performance with 1550 nm bending loss less than 0.003 dB/turn at 30 mm mandrel diameter, less than 0.1 dB/turn at 20 mm mandrel diameter, and less than 0.5 dB at 15 mm mandrel diameter. For the fibers of examples 1-4, the 1550 nm attenuation is less than 0.19 dB/km. For lower attenuation, pure silica core doped with trace of alkali metals, such as K, can be used. Example 5 is a fiber with a pure silica core and a F-dope cladding. The 1550 nm attenuation is less than 0.16 dB/km. The 1550 nm bending loss is less than 0.025 dB/turn at 30 mm mandrel diameter and less than 0.75 dB/turn at 20 mm mandrel diameter. Example 6 is a fiber with a pure silica core and a F-doped cladding for large effective area and low loss. The 1550 nm attenuation of the fiber of example 6 is less than 0.15 dB/km. The 1550 nm bending loss is less than 0.002 dB/turn at 60 mm mandrel diameter and less than 0.02 dB/km at mandrel diameter of 50 mm. While Table 1 provides exemplary fiber profile designs, other suitable profile designs may be used with embodiments described herein.

In some embodiments, the optical fibers described herein may have a mode field diameter in the range of about 8.5 μm to about 11 μm at 1310 nm and in the range of about 10 μm to about 12 μm at 1550 nm. In some embodiments, the optical fibers described herein may have a cable cutoff of less than or equal to (i.e., ≤) 1520 nm, ≤1500 nm, ≤1450 nm, ≤1400 nm, ≤1300 nm, ≤1260 nm, ≤1230 nm, ≤1250 nm, ≤1240 nm, ≤1230 nm, ≤1220 nm, ≤1210 nm, ≤1200 nm, ≤1190 nm, ≤1180 nm, ≤1170 nm, ≤1160 nm, or less. Additionally, the optical fibers described herein may have an effective area at 1550 nm greater than or equal to (i.e., ≥) 75 μm², ≥80 μm², ≥85 μm², ≥90 μm², ≥100 μm², ≥110 μm², or greater. In some embodiments, the optical fibers described herein may have an effective area at 1550 nm greater than or equal to (i.e., ≥) 75 μm² and less than or equal to (i.e., ≤) 115 μm²—including all sub-ranges or values therebetween. The optical fibers described herein may have an effective area at 1310 nm greater than or equal to (i.e., ≥) 60 μm², ≥62 μm², ≥64 μm², ≥68 μm², ≥70 μm², 80 μm², ≥90 μm², or greater. In some embodiments, the optical fibers described herein may have an effective area at 1310 nm greater than or equal to (i.e., ≥) 60 μm² and less than or equal to (i.e., ≤) 95 μm²—including all sub-ranges or values therebetween. The attenuation of the optical fibers disclosed herein is less than or equal to (i.e., ≤) 0.36 dB/km, ≤0.30 dB/km, ≤0.28 dB/km, ≤0.26 dB/km, or less, at a wavelength of 1310 nm. The attenuation of the optical fibers disclosed herein is less than or equal to (i.e., ≤) 0.24 dB/km, ≤0.22 dB/km, ≤0.20 dB/km, ≤0.19 dB/km, ≤0.18 dB/km, ≤0.17 dB/km, ≤0.16 dB/km, ≤0.15 dB/km, or less, at a wavelength of 1550 nm.

### Optical Fiber with Hybrid Coating

### Metal Coating Surrounding Polymer Coating

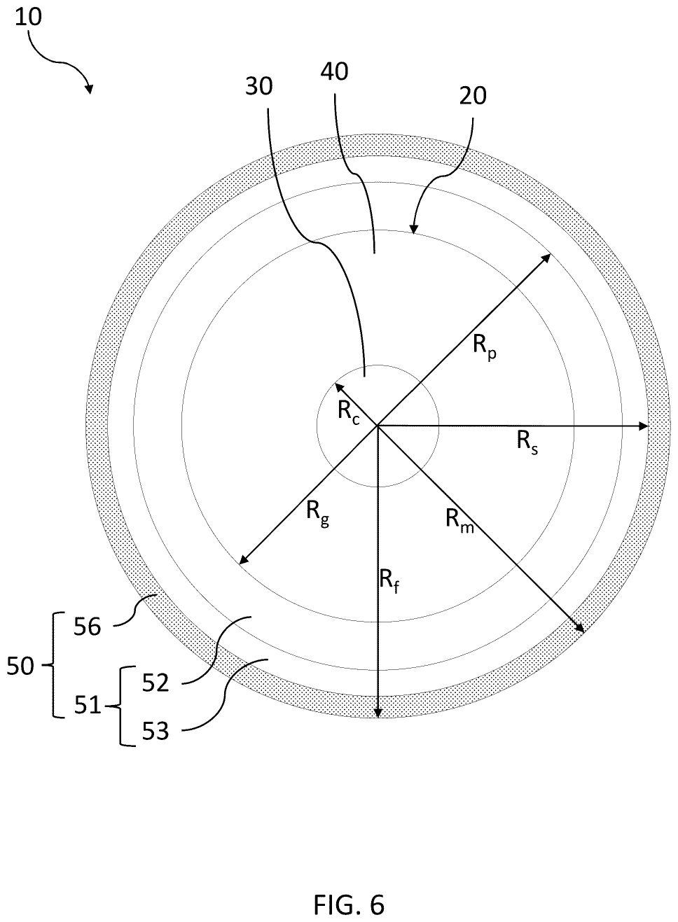

FIG. 6 schematically illustrates, in cross-sectional view, an example of the optical fiber 10 with a hybrid coating 50 surrounding and directly contacting the glass fiber 20. As shown, the core region 30 includes a radius R_{c} (or diameter D_{c}=2×R_{c}), the glass fiber 20 includes a radius R_{g} (or diameter D_{g}=2×R_{g}), and the coated optical fiber 10 includes a radius R_{f} (or diameter D_{f}=2×R_{f}). The radius R_{c} of the core region 30 may correspond to the radius r₁ of the core region 30 discussed above. The radius R_{g} of the glass fiber 20 corresponds to the outer radius of the cladding region 40, which may correspond to the outer radius r₄ of the outer cladding region 44 discussed above. Depending on the applications, the optical fiber 10 may be single mode or multimode.

### Core Region Diameter and Relative Refractive Index

In some embodiments, the diameter of the core region 30, i.e., D_{c}=2×R_{c}, may be greater than or equal to (i.e., ≥) 6 μm and less than or equal to (i.e., ≤) 100 μm—including all sub-ranges or values therebetween. For example, in some embodiments, the diameter of the core region 30 may be ≥6 μm and ≤100 μm, ≥6 μm and ≤80 μm, ≥6 μm and ≤60 μm, ≥6 μm and ≤40 μm, ≥6 μm and ≤20 μm, ≥6 μm and ≤10 μm, ≥10 μm and ≤100 μm, ≥10 μm and ≤80 μm, ≥10 μm and ≤60 μm, ≥10 μm and ≤40 μm, ≥10 μm and ≤20 μm, ≥20 μm and ≤100 μm, ≥20 μm and ≤80 μm, ≥20 μm and ≤60 μm, ≥20 μm and ≤40 μm, ≥40 μm and ≤100 μm, ≥40 μm and ≤80 μm, ≥40 μm and ≤60 μm, ≥60 μm and ≤100 μm, ≥60 μm and ≤80 μm, or ≥80 μm and ≤100 μm. In some embodiments, the diameter of the core region 30 may be greater than or equal to (i.e., ≥) 6 μm, ≥10 μm, ≥15 μm, ≥20 μm, ≥25 μm, ≥35 μm, ≥45 μm, ≥55 μm, ≥65 μm, ≥75 μm, ≥85 μm, ≥95 μm, or greater. In some embodiments, the diameter of the core region 30 may be less than or equal to (i.e., ≤) 100 μm, ≤90 μm, ≤80 μm, ≤70 μm, ≤60 μm, ≤50 μm, ≤40 μm, ≤30 μm, ≤25 μm, ≤20 μm, ≤15 μm, ≤10 μm, or less.

The maximum relative refractive index within the core region 30 may be greater than or equal to (i.e., ≥) 0.2% and less than or equal to (i.e., ≤) 2%—including all sub-ranges or values therebetween. For example, in some embodiments, the maximum relative refractive index within the core region 30 may be ≥0.2% and ≤2%, ≥0.2% and ≤1.8%, ≥0.2% and ≤1.6%, ≥0.2% and ≤1.4%, ≥0.2% and ≤1.2%, ≥0.2% and ≤1%, ≥0.2% and ≤0.8%, ≥0.2% and ≤0.6%, ≥0.2% and ≤0.4%, ≥0.4% and ≤2%, ≥0.4% and ≤1.8%, ≥0.4% and ≤1.6%, ≥0.4% and ≤1.4%, ≥0.4% and ≤1.2%, ≥0.4% and ≤1%, ≥0.4% and ≤0.8%, ≥0.4% and ≤0.6%, ≥0.6% and ≤2%, ≥0.6% and ≤1.8%, ≥0.6% and ≤1.6%, ≥0.6% and ≤1.4%, ≥0.6% and ≤1.2%, ≥0.6% and ≤1%, ≥0.6% and ≤0.8%, ≥0.8% and ≤2%, ≥0.8% and ≤1.8%, ≥0.8% and ≤1.6%, ≥0.8% and ≤1.4%, ≥0.8% and ≤1.2%, ≥0.8% and ≤1%, ≥1% and ≤2%, ≥1% and ≤1.8%, ≥1% and ≤1.6%, ≥1% and ≤1.4%, ≥1% and ≤1.2%, ≥1.2% and ≤2%, ≥1.2% and ≤1.8%, ≥1.2% and ≤1.6%, ≥1.2% and ≤1.4%, ≥1.4% and ≤2%, ≥1.4% and ≤1.8%, ≥1.4% and ≤1.6%, ≥1.6% and ≤2%, ≥1.6% and ≤1.8%, or ≥1.8% and ≤2%.

In some embodiments, the relative refractive index change within the core region 30 may be greater than or equal to (i.e., ≥) 0.2%, ≥0.3%, ≥0.4%, ≥0.5%, ≥0.6%, ≥0.7%, ≥0.8%, ≥0.9%, ≥1%, ≥1.1%, ≥1.2%, ≥1.3%, ≥1.4%, ≥1.5%, ≥1.6%, ≥1.7%, ≥1.8%, ≥1.9%, or greater. In some embodiments, the relative refractive index change within the core region 30 may be less than or equal to (i.e., ≤) 2%, ≤1.9%, ≤1.8%, ≤1.7%, ≤1.6%, ≤1.5%, ≤1.4%, ≤1.3%, ≤1.2%, ≤1.1%, ≤1%, ≤0.9%, ≤0.8%, ≤0.7%, ≤0.6%, ≤0.5%, ≤0.4%, ≤0.3%, or less.

In some embodiments, the optical fiber 10 may be single mode, and the relative refractive index change within the core region 30 may be less than or equal to 0.5%. In some embodiments, the optical fiber 10 may be multimode, and the relative refractive index change within the core region 30 may be up to 2%.

### Glass Fiber Diameter

In some embodiments, the diameter of the glass fiber 20, i.e., D_{g}=2×R_{g}, or the outer diameter of the cladding region 40, may be greater than or equal to (i.e., ≥) 30 μm and less than or equal to (i.e., ≤) 125 μm—including all sub-ranges or values therebetween. For example, in some embodiments, the diameter of the glass fiber 20 may be ≥30 μm and ≤125 μm, ≥30 μm and ≤110 μm, ≥30 μm and ≤90 μm, ≥30 μm and ≤70 μm, ≥30 μm and ≤50 μm, ≥50 μm and ≤125 μm, ≥50 μm and ≤110 μm, ≥50 μm and ≤90 μm, ≥50 μm and ≤70 μm, ≥70 μm and ≤125 μm, ≥70 μm and ≤110 μm, ≥70 μm and ≤90 μm, ≥90 μm and ≤125 μm, ≥90 μm and ≤110 μm, or ≥110 μm and ≤125 μm. In some embodiments, the diameter of the glass fiber 20 may be greater than or equal to (i.e., ≥) 30 μm, ≥40 μm, ≥50 μm, ≥60 μm, ≥70 μm, ≥80 μm, ≥90 μm, ≥100 μm, ≥110 μm, ≥120 μm, or greater. In some embodiments, the diameter of the glass fiber 20 may be less than or equal to (i.e., ≤) 125 μm, ≤115 μm, ≤105 μm, ≤95 μm, ≤85 μm, ≤75 μm, ≤65 μm, ≤55 μm, ≤45 μm, ≤35 μm, or less.

### Coated Fiber Diameter

In some embodiments, the diameter of the coated optical fiber 10, i.e., D_{f}=2×R_{f}, may be greater than or equal to (i.e., ≥) 40 μm and less than or equal to (i.e., ≤) 170 μm—including all sub-ranges or values therebetween. For example, in some embodiments, the diameter of the coated optical fiber 10 may be ≥40 μm and ≤170 μm, ≥40 μm and ≤150 μm, ≥40 μm and ≤130 μm, ≥40 μm and ≤110 μm, ≥40 μm and ≤90 μm, ≥40 μm and ≤70 μm, ≥40 μm and ≤50 μm, ≥50 μm and ≤170 μm, ≥50 μm and ≤150 μm, ≥50 μm and ≤130 μm, ≥50 μm and ≤110 μm, ≥50 μm and ≤90 μm, ≥50 μm and ≤70 μm, ≥70 μm and ≤170 μm, ≥70 μm and ≤150 μm, ≥70 μm and ≤130 μm, ≥70 μm and ≤110 μm, ≥70 μm and ≤90 μm, ≥90 μm and ≤170 μm, ≥90 μm and ≤150 μm, ≥90 μm and ≤130 μm, ≥90 μm and ≤110 μm, ≥110 μm and ≤170 μm, ≥110 μm and ≤150 μm, ≥110 μm and ≤130 μm, ≥130 μm and ≤170 μm, ≥130 μm and ≤150 μm, or ≥150 μm and ≤170 μm.

In some embodiments, the diameter of the coated optical fiber 10 may be greater than or equal to (i.e., ≥) 40 μm, ≥45 μm, ≥50 μm, ≥55 μm, ≥60 μm, ≥65 μm, ≥70 μm, ≥75μm, ≥80 μm, ≥85 μm, ≥90 μm, ≥95 μm, ≥100 μm, ≥105 μm, ≥110 μm, ≥115 μm, ≥120μm, ≥125 μm, ≥130 μm, ≥135 μm, ≥140 μm, ≥145 μm, ≥150 μm, ≥155 μm, ≥160 μm, ≥165 μm, or greater. In some embodiments, the diameter of the metal coating 56 may be less than or equal to (i.e., ≤) 170 μm, ≤165 μm, ≤160 μm, ≤155 μm, ≤150 μm, ≤145 μm, ≤140μm, ≤135 μm, ≤130 μm, ≤125 μm, ≤120 μm, ≤115 μm, ≤110 μm, ≤105 μm, ≤100 μm, ≤95 μm, ≤90 μm, ≤85 μm, ≤80 μm, ≤75 μm, ≤70 μm, ≤65 μm, ≤60 μm, ≤55 μm, ≤50μm, ≤45 μm, or less.

### Hybrid Coating Structure

In some embodiments, such as the embodiment shown in FIG. 6, the hybrid coating 50 may include a polymer coating 51 and a metal coating 56 surrounding and directly contacting the polymer coating 51.

In some embodiments, the polymer coating 51 may include a primary coating 52 surrounding and directly contacting the glass fiber 20, or more specifically, the cladding region 40 of the glass fiber 20, and a secondary coating 53 surrounding and directly contacting the primary coating 52. As used herein, the primary coating 52 may also be referred to as a first coating or a low-modulus coating, and the secondary coating 53 may also be referred to as a second coating or a high-modulus coating, as will be discussed in more detail below. In some embodiments, the primary coating 52 may include an inner radius corresponding to the radius R_{g} of the glass fiber 20 (or the outer radius of the cladding region 40) and an outer radius Rₚ. In some embodiments, the secondary coating 53 may include an inner radius corresponding to the outer radius Rₚ of the primary coating 52 and an outer radius Rₛ. In some embodiments, the primary coating 52 may be the innermost coating layer of the polymer coating 51, and the secondary coating 53 may be the outermost coating layer of the polymer coating 51. Thus, in some embodiments, the polymer coating 51 may include an inner radius corresponding to the inner radius of the primary coating 52 and an outer radius corresponding to the outer radius Rₛ of the secondary coating 53.

In some embodiments, the metal coating 56 may surround and directly contact the secondary coating 53. Thus, in some embodiments, the metal coating 56 may include an inner radius corresponding to the outer radius Rₛ of the secondary coating 53 and an outer radius Rₘ. In some embodiments, the metal coating 56 may be the outermost coating layer of the hybrid coating 50 and the outermost layer of the optical fiber 10. Thus, the hybrid coating 50 may include an inner radius corresponding to the inner radius of the polymer coating 51 or the inner radius of the primary coating 52 and an outer radius corresponding to the outer radius Rm of the metal coating 56, and the coated optical fiber 10 may include a radius corresponding to the outer radius Rm of the metal coating 56.

In some embodiments, each of the primary coating 52, the secondary coating 53, and/or the metal coating 56 of the hybrid coating 50 may include an annular region that may be compositionally and/or structurally homogeneous. For example, the primary coating 52 may include an annular region that may be compositionally and/or structurally homogeneous throughout the entire thickness of the primary coating 52 in some embodiments. The secondary coating 53 may include an annular region that may be compositionally and/or structurally homogeneous throughout the entire thickness of the secondary coating 53 in some embodiments. The metal coating 56 may include an annular region that may be compositionally and/or structurally homogeneous throughout the entire thickness of the metal coating 56 in some embodiments. In some embodiments, one or more of the primary coating 52, the secondary coating 53, and/or the metal coating 56 may include compositional and/or structural variation or inhomogeneity within the respective annular regions.

### Primary Coating Diameter

In some embodiments, such as the embodiment shown in FIG. 6, the outer diameter of the primary coating 52, i.e., Dₚ=2×Rₚ, may be greater than or equal to (i.e., ≥) 32 μm and less than or equal to (i.e., ≤) 145 μm—including all sub-ranges or values therebetween. For example, in some embodiments, the outer diameter of the primary coating 52 may be ≥32 μm and ≤145 μm, ≥32 μm and ≤125 μm, ≥32 μm and ≤105 μm, ≥32 μm and ≤85 μm, >32 μm and ≤65 μm, ≥32 μm and ≤45 μm, ≥45 μm and ≤145 μm, ≥45 μm and ≤125 μm, ≥45 μm and ≤105 μm, ≥45 μm and ≤85 μm, ≥45 μm and ≤65 μm, ≥65 μm and ≤145 μm, ≥65 μm and ≤125 μm, ≥65 μm and ≤105 μm, ≥65 μm and ≤85 μm, ≥85 μm and ≤145 μm, ≥85 μm and ≤125 μm, ≥85 μm and ≤105 μm, ≥105 μm and ≤145 μm, ≥105 μm and ≤125 μm, or ≥125 μm and ≤145 μm. In some embodiments, the outer diameter of the primary coating 52 may be greater than or equal to (i.e., ≥) 32 μm, ≥40 μm, ≥50 μm, ≥60 μm, ≥70 μm, ≥80 μm, ≥90 μm, ≥100 μm, ≥110 μm, ≥120 μm, ≥130 μm, ≥140 μm, or greater. In some embodiments, the outer diameter of the primary coating 52 may be less than or equal to (i.e., ≤) 145 μm, ≤135 μm, ≤125 μm, ≤115 μm, ≤105 μm, ≤95 μm, ≤85 μm, ≤75 μm, ≤65 μm, ≤55 μm, ≤45 μm, ≤35 μm, or less.

### Secondary Coating Diameter

In some embodiments, such as the embodiment shown in FIG. 6, the outer diameter of the secondary coating 53, i.e., Dₛ=2×Rₛ, may be greater than or equal to (i.e., ≥) 40 μm and less than or equal to (i.e., ≤) 165 μm—including all sub-ranges or values therebetween. For example, in some embodiments, the outer diameter of the secondary coating 53 may be ≥40 μm and ≤165 μm, ≥40 μm and ≤145 μm, ≥40 μm and ≤125 μm, ≥40 μm and ≤105 μm, ≥40 μm and ≤85 μm, ≥40 μm and ≤65 μm, ≥40 μm and ≤45 μm, ≥45 μm and ≤165 μm, ≥45 μm and ≤145 μm, ≥45 μm and ≤125 μm, ≥45 μm and ≤105 μm, ≥45 μm and ≤85 μm, ≥45 μm and ≤65 μm, ≥65 μm and ≤165 μm, ≥65 μm and ≤145 μm, ≥65 μm and ≤125 μm, ≥65 μm and ≤105 μm, ≥65 μm and ≤85 μm, ≥85 μm and ≤165 μm, ≥85 μm and ≤145 μm, ≥85 μm and ≤125 μm, ≥85 μm and ≤105 μm, ≥105 μm and ≤165 μm, ≥105 μm and ≤145 μm, ≥105 μm and ≤125 μm, ≥125 μm and ≤165 μm, ≥125 μm and ≤145 μm, or ≥145 μm and ≤165 μm. In some embodiments, the outer diameter of the secondary coating 53 may be greater than or equal to (i.e., ≥) 40 μm, ≥50 μm, ≥60 μm, ≥70 μm, ≥80 μm, ≥90 μm, ≥100 μm, ≥110 μm, ≥120 μm, ≥130 μm, ≥140 μm, ≥150 μm, ≥160 μm, or greater. In some embodiments, the outer diameter of the secondary coating 53 may be less than or equal to (i.e., ≤) 165 μm, ≤155 μm, ≤145 μm, ≤135 μm, ≤125 μm, ≤115 μm, ≤105 μm, ≤95 μm, ≤85 μm, ≤75 μm, ≤65 μm, ≤55 μm, ≤45 μm, or less.

### Metal Coating Diameter

In some embodiments, such as the embodiment shown in FIG. 6, the outer diameter of the metal coating 56, i.e., Dₘ=2×Rₘ, may be greater than or equal to (i.e., ≥) 40.2 μm and less than or equal to (i.e., ≤) 170 μm—including all sub-ranges or values therebetween. For example, in some embodiments, the outer diameter of the metal coating 56 may be ≥40.2 μm and ≤170 μm, ≥40.2 μm and ≤150 μm, ≥40.2 μm and ≤130 μm, ≥40.2 μm and ≤110 μm, ≥40.2 μm and ≤90 μm, ≥40.2 μm and ≤70 μm, ≥40.2 μm and ≤50 μm, ≥50 μm and ≤170 μm, ≥50 μm and ≤150 μm, ≥50 μm and ≤130 μm, ≥50 μm and ≤110 μm, ≥50 μm and ≤90 μm, ≥50 μm and ≤70 μm, ≥70 μm and ≤170 μm, ≥70 μm and ≤150 μm, ≥70 μm and ≤130 μm, ≥70 μm and ≤110 μm, ≥70 μm and ≤90 μm, ≥90 μm and ≤170 μm, >90 μm and ≤150 μm, ≥90 μm and ≤130 μm, ≥90 μm and ≤110 μm, ≥110 μm and ≤170 μm, ≥110 μm and ≤150 μm, ≥110 μm and ≤130 μm, ≥130 μm and ≤170 μm, ≥130 μm and ≤150 μm, or ≥150 μm and ≤170 μm. In some embodiments, the outer diameter of the metal coating 56 may be greater than or equal to (i.e., ≥) 40.2 μm, ≥45 μm, ≥50 μm, ≥55 μm, ≥60 μm, ≥65 μm, ≥70 μm, ≥75 μm, ≥80 μm, ≥85 μm, ≥90 μm, ≥95 μm, ≥100 μm, ≥105 μm, ≥110 μm, ≥115 μm, ≥120 μm, ≥125 μm, ≥130 μm, ≥135 μm, ≥140 μm, ≥145 μm, ≥150 μm, ≥155 μm, ≥160 μm, ≥165 μm, or greater. In some embodiments, the outer diameter of the metal coating 56 may be less than or equal to (i.e., ≤) 170 μm, ≤165 μm, ≤160 μm, ≤155 μm, ≤150 μm, ≤145 μm, ≤140 μm, ≤135 μm, ≤130 μm, ≤125 μm, ≤120 μm, ≤115 μm, ≤110 μm, ≤105 μm, ≤100 μm, ≤95 μm, ≤90 μm, ≤85 μm, ≤80 μm, ≤75 μm, ≤70 μm, ≤65 μm, ≤60 μm, ≤55 μm, ≤50 μm, ≤45 μm, or less.

### Polymer Coating Surrounding Metal Coating

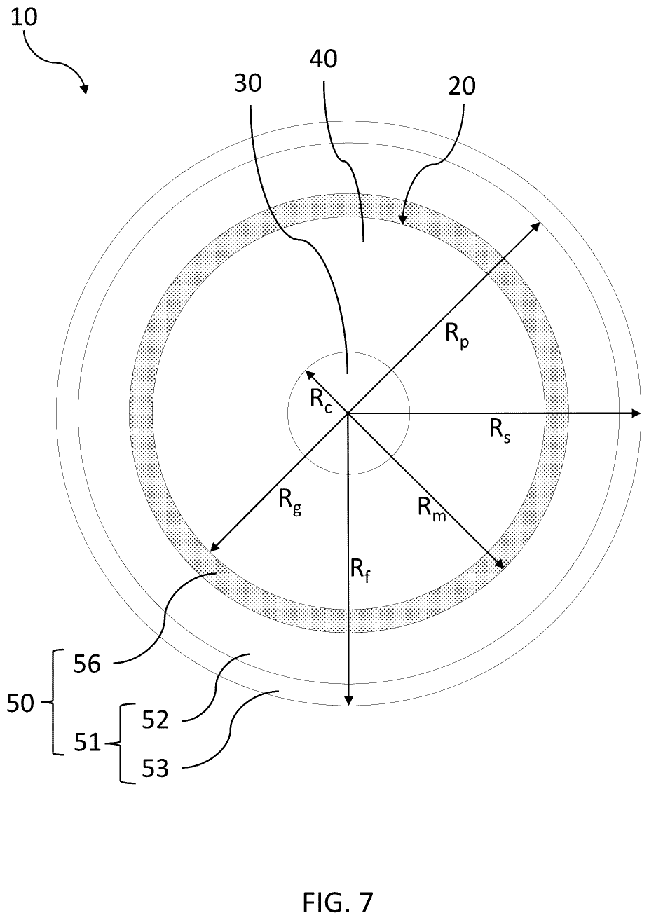

While in FIG. 6, the polymer coating 51 is shown to be disposed between the glass fiber 20 and the metal coating 56, in some embodiments, the metal coating 56 may be disposed between the glass fiber 20 and the polymer coating 51, such as shown in FIG. 7. Thus, in some embodiments, the metal coating 56 may be the inner coating of the hybrid coating 50, and the polymer coating 51 may be the outer coating of the hybrid coating 50 surrounding and directly contacting the metal coating 56. The metal coating 56 may surround and directly contact the glass fiber 20, or more specifically, the cladding region 40. The metal coating 56 may have an inner radius corresponding to the radius R_{g} of the glass fiber 20 or the outer radius of the cladding region 40. The primary coating 52 may surround and directly contact the metal coating 56 and have an inner radius corresponding to the outer radius Rₘ of the metal coating 56. In some embodiments, the metal coating 56 may be the innermost coating layer of the polymer coating 51. In some embodiments, the secondary coating 53 may be the outermost coating layer of the polymer coating 51. Thus, in some embodiments, the polymer coating 51 may have an inner radius corresponding to the inner radius of the metal coating 56 and an outer radius corresponding to the outer radius Rₛ of the secondary coating 53.

### Metal Coating Diameter

In some embodiments, such as the embodiment shown in FIG. 7, the outer diameter of the metal coating 56, i.e., Dₘ=2×Rₘ, may be greater than or equal to (i.e., ≥) 30.2 μm and less than or equal to (i.e., ≤) 130 μm—including all sub-ranges or values therebetween. For example, in some embodiments, the outer diameter of the metal coating 56 may be ≥30.2 μm and ≤130 μm, ≥30.2 μm and ≤110 μm, ≥30.2 μm and ≤90 μm, ≥30.2 μm and ≤70 μm, ≥30.2 μm and ≤50 μm, ≥50 μm and ≤130 μm, ≥50 μm and ≤110 μm, ≥50 μm and ≤90 μm, ≥50 μm and ≤70 μm, ≥70 μm and ≤130 μm, ≥70 μm and ≤110 μm, ≥70 μm and ≤90 μm, ≥90 μm and ≤130 μm, ≥90 μm and ≤110 μm, or ≥110 μm and ≤130 μm. In some embodiments, the outer diameter of the metal coating 56 may be greater than or equal to (i.e., ≥) 30.2 μm, ≥35 μm, ≥40 μm, ≥45 μm, ≥50 μm, ≥55 μm, ≥60 μm, ≥65 μm, ≥70 μm, ≥75 μm, ≥80 μm, ≥85 μm, ≥90 μm, ≥95 μm, ≥100 μm, ≥105 μm, ≥110 μm, ≥115 μm, ≥120 μm, ≥125 μm, or greater. In some embodiments, the outer diameter of the metal coating 56 may be less than or equal to (i.e., ≤) 130 μm, ≤125 μm, ≤120 μm, ≤115 μm, ≤110 μm, ≈105 μm, ≤100 μm, ≤95 μm, ≤90 μm, ≤85 μm, ≤80 μm, ≤75 μm, ≤70 μm, ≤65 μm, ≤60 μm, ≤55 μm, ≤50 μm, ≤45 μm, ≤40 μm, ≤35 μm, or less.

### Primary Coating Diameter

In some embodiments, such as the embodiment shown in FIG. 7, the outer diameter of the primary coating 52, i.e., Dₚ=2×Rₚ, may be greater than or equal to (i.e., ≥) 32 μm and less than or equal to (i.e., ≤) 165 μm—including all sub-ranges or values therebetween. For example, in some embodiments, the outer diameter of the primary coating 52 may be ≥32 μm and ≤165 μm, ≥32 μm and ≤145 μm, ≥32 μm and ≤125 μm, ≥32 μm and ≤105 μm, ≥32 μm and ≤85 μm, ≥32 μm and ≤65 μm, ≥32 μm and ≤45 μm, ≥45 μm and ≤165 μm, ≥45 μm and ≤145 μm, ≥45 μm and ≤125 μm, ≥45 μm and ≤105 μm, ≥45 μm and ≤85 μm, ≥45 μm and ≤65 μm, ≥65 μm and ≤165 μm, ≥65 μm and ≤145 μm, ≥65 μm and ≤125 μm, ≥65 μm and ≤105 μm, ≥65 μm and ≤85 μm, ≥85 μm and ≤165 μm, ≥85 μm and ≤145 μm, ≥85 μm and ≤125 μm, ≥85 μm and ≤105 μm, ≥105 μm and ≤165 μm, ≥105 μm and ≤145 μm, ≥105 μm and ≤125 μm, ≥125 μm and ≤165 μm, ≥125 μm and ≤145 μm, or ≥145 μm and ≤165 μm. In some embodiments, the outer diameter of the primary coating 52 may be greater than or equal to (i.e., ≥) 32 μm, ≥40 μm, ≥50 μm, ≥60 μm, ≥70 μm, ≥80 μm, ≥90 μm, ≥100 μm, ≥110 μm, ≥120 μm, ≥130 μm, ≥140 μm, ≥150 μm, ≥160 μm, or greater. In some embodiments, the outer diameter of the primary coating 52 may be less than or equal to (i.e., ≤) 165 μm, ≤155 μm, ≤145 μm, ≤135 μm, ≤125 μm, ≤115 μm, ≤105 μm, ≤95 μm, ≤85 μm, ≤75 μm, ≤65 μm, ≤55 μm, ≤45 μm, ≤35 μm, or less.

### Secondary Coating Diameter

In some embodiments, such as the embodiment shown in FIG. 7, the outer diameter of the secondary coating 53, i.e., Dₛ=2×Rₛ, may be greater than or equal to (i.e., ≥) 40 μm and less than or equal to (i.e., ≤) 170 μm—including all sub-ranges or values therebetween. For example, in some embodiments, the outer diameter of the secondary coating 53 may be ≥40 μm and ≤170 μm, ≥40 μm and ≤150 μm, ≥40 μm and ≤130 μm, ≥40 μm and ≤110 μm, ≥40 μm and ≤90 μm, ≥40 μm and ≤70 μm, ≥40 μm and ≤50 μm, ≥50 μm and ≤170 μm, ≥50 μm and ≤150 μm, ≥50 μm and ≤130 μm, ≥50 μm and ≤110 μm, ≥50 μm and ≤90 μm, ≥50 μm and ≤70 μm, ≥70 μm and ≤170 μm, ≥70 μm and ≤150 μm, ≥70 μm and ≤130 μm, ≥70 μm and ≤110 μm, ≥70 μm and ≤90 μm, ≥90 μm and ≤170 μm, ≥90 μm and ≤150 μm, ≥90 μm and ≤130 μm, ≥90 μm and ≤110 μm, ≥110 μm and ≤170 μm, ≥110 μm and ≤150 μm, ≥110 μm and ≤130 μm, ≥130 μm and ≤170 μm, ≥130 μm and ≤150 μm, or ≥150 μm and ≤170 μm. In some embodiments, the outer diameter of the secondary coating 53 may be greater than or equal to (i.e., ≥) 40 μm, ≥45 μm, ≥50 μm, ≥55 μm, ≥60 μm, ≥65 μm, ≥70 μm, ≥75 μm, ≥80 μm, ≥85 μm, ≥90 μm, ≥95 μm, ≥100 μm, ≥105 μm, ≥110 μm, ≥115 μm, ≥120 μm, ≥125 μm, ≥130 μm, ≥135 μm, ≥140 μm, ≥145 μm, ≥150 μm, ≥155 μm, ≥160 μm, ≥165 μm, or greater. In some embodiments, the outer diameter of the secondary coating 53 may be less than or equal to (i.e., ≤) 170 μm, ≤165 μm, ≤160 μm, ≤155 μm, ≤150 μm, ≤145 μm, ≤140 μm, ≤135 μm, ≤130 μm, ≤125 μm, ≤120 μm, ≤115 μm, ≤110 μm, ≤105 μm, ≤100 μm, ≤95 μm, ≤90 μm, ≤85 μm, ≤80 μm, ≤75 μm, ≤70 μm, ≤65 μm, ≤60 μm, ≤55 μm, ≤50 μm, ≤45 μm, or less.

### Metal Coating between Primary Coating and Secondary Coating

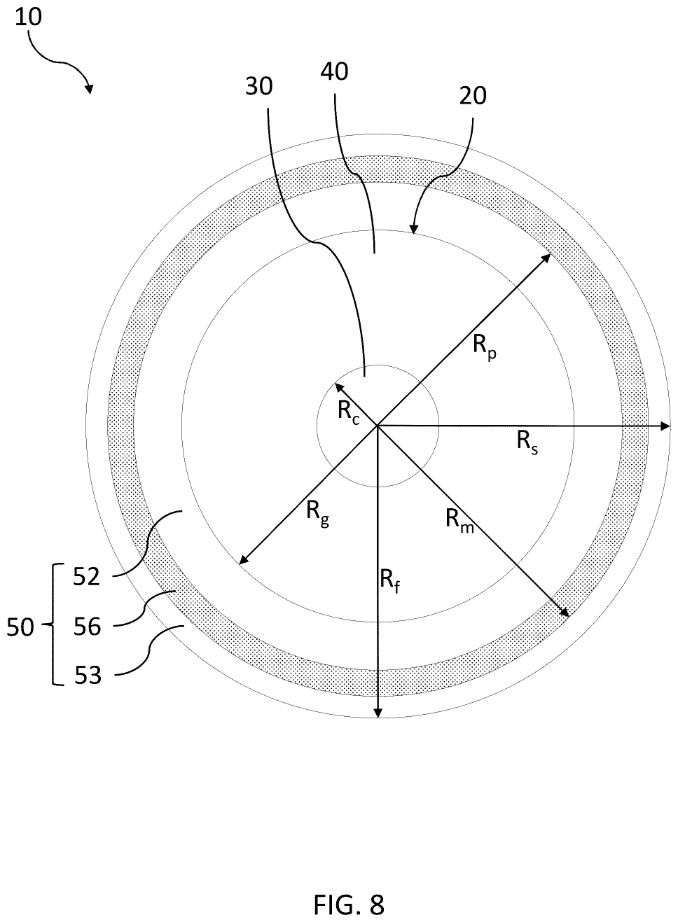

While FIGS. 6 and 7 depict exemplary hybrid coatings 50 in which the primary coating 52 and the secondary coating 53 may be adjacent, in some embodiments, the primary coating 52 and the secondary coating 53 may be separated by the metal coating 56. In other words, the metal coating 56 may be disposed between the primary coating 52 and the secondary coating 53 in some embodiments, such as shown in FIG. 8. The primary coating 52 may surround and directly contact the glass fiber 20, the metal coating 56 may surround and directly contact the primary coating 52, and the secondary coating 53 may surround and directly contact the metal coating 56. Each of the primary coating 52, the secondary coating 53, and/or the metal coating 56 disposed therebetween may include a respective thickness similar to, or the same as, the respective thicknesses of the primary coating 52, the secondary coating 53, and/or the metal coating 56 where the primary coating 52 and the secondary coating 53 may be adjacent and the metal coating 56 may be disposed on the interior or exterior of the polymer coating 51.

### Thicknesses of Various Coating Layers

### Metal Coating Thickness

In some embodiments, the thickness of the metal coating 56, as defined by the difference between the outer radius Rₘ of the metal coating 56 and the inner radius of the metal coating 56 (which may correspond to the outer radius Rₛ of the secondary coating 53 in some embodiments such as shown in FIG. 6, or may correspond to the radius R_{g} of the glass fiber 20 in some embodiments such as shown in FIG. 7, or may correspond to the outer radius Rₚ of the primary coating 52 in some embodiments such as shown in FIG. 8), may be greater than or equal to (i.e., ≥) 0.1 μm and less than or equal to (i.e., ≤) 5 μm—including all sub-ranges or values therebetween. For example, in some embodiments, the metal coating 56 may be ≥0.1 μm and ≤5 μm, ≥0.1 μm and ≤4.5 μm, ≥0.1 μm and ≤4 μm, ≥0.1 μm and ≤3.5 μm, ≥0.1 μm and ≤3 μm, ≥0.1 μm and ≤2.5 μm, ≥0.1 μm and ≤2 μm, ≥0.1 μm and ≤1.75 μm, ≥0.1 μm and ≤1.5 μm, ≥0.1 μm and ≤1.25 μm, ≥0.1 μm and ≤1 μm, ≥0.1 μm and ≤0.75 μm, ≥0.1 μm and ≤0.5 μm, ≥0.1 μm and ≤0.25, ≥0.25 μm and ≤5 μm, ≥0.25 μm and ≤4.5 μm, ≥0.25 μm and ≤4 μm, ≥0.25 μm and ≤3.5 μm, ≥0.25 μm and ≤3 μm, ≥0.25 μm and ≤2.5 μm, ≥0.25 μm and ≤2 μm, ≥0.25 μm and ≤1.75 μm, ≥0.25 μm and ≤1.5 μm, ≥0.25 μm and ≤1.25 μm, ≥0.25 μm and ≤1 μm, ≥0.25 μm and ≤0.75 μm, ≥0.25 μm and ≤0.5 μm, ≥0.5 μm and ≤5 μm, ≥0.5 μm and ≤4.5 μm, ≥0.5 μm and ≤4 μm, ≥0.5 μm and ≤3.5 μm, ≥0.5 μm and ≤3 μm, ≥0.5 μm and ≤2.5 μm, ≥0.5 μm and ≤2 μm, ≥0.5 μm and ≤1.75 μm, ≥0.5 μm and ≤1.5 μm, ≥0.5 μm and ≤1.25 μm, ≥0.5 μm and ≤1 μm, ≥0.5 μm and ≤0.75 μm, ≥0.75 μm and ≤5 μm, ≥0.75 μm and ≤4.5 μm, ≥0.75 μm and ≤4 μm, ≥0.75 μm and ≤3.5 μm, ≥0.75 μm and ≤3 μm, ≥0.75 μm and ≤2.5 μm, ≥0.75 μm and ≤2 μm, ≥0.75 μm and ≤1.75 μm, ≥0.75 μm and ≤1.5 μm, ≥0.75 μm and ≤1.25 μm, ≥0.75 μm and ≤1 μm, ≥1 μm and ≤5 μm, ≥1 μm and ≤4.5 μm, ≥1 μm and ≤4 μm, ≥1 μm and ≤3.5 μm, ≥1 μm and ≤3 μm, ≥1 μm and ≤2.5 μm, ≥1 μm and ≤2 μm, ≥1 μm and ≤1.75 μm, ≥1 μm and ≤1.5 μm, ≥1 μm and ≤1.25 μm, ≥1.25 μm and ≤5 μm, ≥1.25 μm and ≤4.5 μm, ≥1.25 μm and ≤4 μm, ≥1.25 μm and ≤3.5 μm, ≥1.25 μm and ≤3 μm, ≥1.25 μm and ≤2.5 μm, ≥1.25 μm and ≤2 μm, ≥1.25 μm and ≤1.75 μm, ≥1.25 μm and ≤1.5 μm, >1.5 μm and ≤5 μm, ≥1.5 μm and ≤4.5 μm, ≥1.5 μm and ≤4 μm, ≥1.5 μm and ≤3.5 μm, ≥1.5 μm and ≤3 μm, ≥1.5 μm and ≤2.5 μm, ≥1.5 μm and ≤2 μm, ≥1.5 μm and ≤1.75 μm, ≥1.75 μm and ≤5 μm, ≥1.75 μm and ≤4.5 μm, ≥1.75 μm and ≤4 μm, ≥1.75 μm and ≤3.5 μm, ≥1.75 μm and ≤3 μm, ≥1.75 μm and ≤2.5 μm, ≥1.75 μm and ≤2 μm, ≥2 μm and ≤5 μm, ≥2 μm and ≤4.5 μm, ≥2 μm and ≤4 μm, ≥2 μm and ≤3.5 μm, ≥2 μm and ≤3 μm, ≥2 μm and ≤2.5 μm, ≥2.5 μm and ≤5 μm, ≥2.5 μm and ≤4.5 μm, ≥2.5 μm and ≤4 μm, ≥2.5 μm and ≤3.5 μm, ≥2.5 μm and ≤3 μm, ≥3 μm and ≤5 μm, ≥3 μm and ≤4.5 μm, ≥3 μm and ≤4 μm, ≥3 μm and ≤3.5 μm, ≥3.5 μm and ≤5 μm, ≥3.5 μm and ≤4.5 μm, ≥3.5 μm and ≤4 μm, ≥4 μm and ≤5 μm, ≥4 μm and ≤4.5 μm, or ≥4.5 μm and ≤5 μm.

In some embodiments, the thickness of the metal coating 56 may be greater than or equal to (i.e., ≥) 0.1 μm, ≥0.2 μm, ≥0.3 μm, ≥0.4 μm, ≥0.5 μm, ≥0.6 μm, ≥0.7 μm, ≥0.8 μm, ≥0.9 μm, ≥1.0 μm, ≥1.1 μm, ≥1.2 μm, ≥1.3 μm, ≥1.4 μm, ≥1.5 μm, ≥1.6 μm, ≥1.7 μm, ≥1.8 μm, ≥1.9 μm, ≥2.0 μm, ≥2.1 μm, ≥2.2 μm, ≥2.3 μm, ≥2.4 μm, ≥2.5 μm, ≥2.6 μm, ≥2.7 μm, ≥2.8 μm, ≥2.9 μm, ≥3.0 μm, ≥3.1 μm, ≥3.2 μm, ≥3.3 μm, ≥3.4 μm, ≥3.5 μm, ≥3.6 μm, ≥3.7 μm, ≥3.8 μm, ≥3.9 μm, ≥4.0 μm, ≥4.1 μm, ≥4.2 μm, ≥4.3 μm, ≥4.4 μm, ≥4.5 μm, ≥4.6 μm, ≥4.7 μm, ≥4.8 μm, ≥4.9 μm, or greater.

In some embodiments, the thickness of the metal coating 56 may be less than or equal to (i.e., ≤) 5 μm, ≤4.9 μm, ≤4.8 μm, ≤4.7 μm, ≤4.6 μm, ≤4.5 μm, ≤4.4 μm, ≤4.3 μm, ≤4.2 μm, ≤4.1 μm, ≤4.0 μm, ≤3.9 μm, ≤3.8 μm, ≤3.7 μm, ≤3.6 μm, ≤3.5 μm, ≤3.4 μm, ≤3.3 μm, ≤3.2 μm, ≤3.1 μm, ≤3.0 μm, ≤2.9 μm, ≤2.8 μm, ≤2.7 μm, ≤2.6 μm, ≤2.5 μm, ≤2.4 μm, ≤2.3 μm, ≤2.2 μm, ≤2.1 μm, ≤2.0 μm, ≤1.9 μm, ≤1.8 μm, ≤1.7 μm, ≤1.6 μm, ≤1.5 μm, ≤1.4 μm, ≤1.3 μm, ≤1.2 μm, ≤1.1 μm, ≤1.0 μm, ≤0.9 μm, ≤0.8 μm, ≤0.7 μm, ≤0.6 μm, ≤0.5 μm, ≤0.4 μm, ≤0.3 μm, ≤0.2 μm, or less.

The thickness of the metal coating 56 may be at least 0.1 μm or greater such that the metal coating 56 may provide sufficient protection for the glass fiber 20 and/or the polymer coating 51. Moreover, the thickness of the metal coating 56 may be at least 0.1 μm or greater to accommodate various coating application methods to ensure a uniform, or substantially uniform, thickness of the metal coating 56 may be applied. A uniform thickness of the metal coating 56 may ensure concentricity of the metal coating 56 about the centerline axis of the optical fiber 10, which may be desired for making low insertion loss connectors in applications such as high density optical interconnects for data centers.

Additionally, the thickness of the metal coating 56 may not be greater than 5 μm so as not to increase attenuation. A thick metal coating may stiffen the fiber, thereby increasing microbending induced loss and overall attenuation. Further, a thickness of greater than 5 μm may increase coated fiber diameter and/or pose challenges for installation for applications such as high density optical interconnects for data centers (e.g., placement of the optical fiber into the ferrule of the optical fiber connectors).

### Primary Coating Thickness

In some embodiments, the thickness of the primary coating 52, as defined by the difference between the outer radius Rₚ of the primary coating 52 and the inner radius of the primary coating 52 (which may correspond to the radius R_{g} of the glass fiber 20 in some embodiments such as shown in FIG. 6 and/or FIG. 8, or may correspond to the outer radius Rₘ of the metal coating 56 in some embodiments such as shown in FIG. 7), may be greater than or equal to (i.e., ≥) 1 μm and less than or equal to (i.e., ≤) 15 μm—including all sub-ranges or values therebetween. For example, in some embodiments, the thickness of the primary coating 52 may be ≥1 μm and ≤15 μm, ≥1 μm and ≤13 μm, ≥1 μm and ≤11 μm, ≥1 μm and ≤9 μm, ≥1 μm and ≤7 μm, ≥1 μm and ≤5 μm, ≥1 μm and ≤3 μm, ≥3 μm and ≤15 μm, ≥3 μm and ≤13 μm, ≥3 μm and ≤11 μm, ≥3 μm and ≤9 μm, ≥3 μm and ≤7 μm, ≥3 μm and ≤5 μm, ≥5 μm and ≤15 μm, ≥5 μm and ≤13 μm, ≥5 μm and ≤11 μm, ≥5 μm and ≤9 μm, ≥5 μm and ≤7 μm, ≥7 μm and ≤15 μm, ≥7 μm and ≤13 μm, ≥7 μm and ≤11 μm, ≥7 μm and ≤9 μm, ≥9 μm and ≤15 μm, ≥9 μm and ≤13 μm, ≥9 μm and ≤11 μm, ≥11 μm and ≤15 μm, ≥11 μm and ≤13 μm, or ≥13 μm and ≤15 μm.

In some embodiments, the thickness of the primary coating 52 may be greater than or equal to (i.e., ≥) 1 μm, ≥2 μm, ≥3 μm, ≥4 μm, ≥5 μm, ≥6 μm, ≥7 μm, ≥8 μm, ≥9 μm, ≥10 μm, ≥11 μm, ≥12 μm, ≥13 μm, ≥14 μm, or greater. In some embodiments, the thickness of the primary coating 52 may be less than or equal to (i.e., ≤) 15 μm, ≤14 μm, ≤13 μm, ≤12 μm, ≤11 μm, ≤10 μm, ≤9 μm, ≤8 μm, ≤7 μm, ≤6 μm, ≤5 μm, ≤4 μm, ≤3 μm, ≤2 μm, or less.

### Secondary Coating Thickness

In some embodiments, the thickness of the secondary coating 53, as defined by the difference between the outer radius Rs of the secondary coating 53 and the inner radius of the secondary coating 53 (which may correspond to the outer radius Rp of the primary coating 52 in some embodiments such as shown in FIG. 6 and/or FIG. 7, or may correspond to the outer radius Rm of the metal coating 56 in some embodiments such as shown in FIG. 8), may be greater than or equal to (i.e., ≥) 4 μm and less than or equal to (i.e., ≤) 15 μm—including all sub-ranges or values therebetween. For example, in some embodiments, the thickness of the secondary coating 53 may be ≥4 μm and ≤15 μm, ≥4 μm and ≤13 μm, ≥4 μm and ≤11 μm, ≥4 μm and ≤9 μm, ≥4 μm and ≤7 μm, ≥4 μm and ≤5 μm, ≥5 μm and ≤15 μm, ≥5 μm and ≤13 μm, ≥5 μm and ≤11 μm, ≥5 μm and ≤9 μm, ≥5 μm and ≤7 μm, ≥7 μm and ≤15 μm, ≥7 μm and ≤13 μm, ≥7 μm and ≤11 μm, ≥7 μm and ≤9 μm, ≥9 μm and ≤15 μm, ≥9 μm and ≤13 μm, ≥9 μm and ≤11 μm, ≥11 μm and ≤15 μm, ≥11 μm and ≤13 μm, or ≥13 μm and ≤15 μm.

In some embodiments, the thickness of the secondary coating 53 may be greater than or equal to (i.e., ≥) 4 μm, ≥5 μm, ≥6 μm, ≥7 μm, ≥8 μm, ≥9 μm, ≥10 μm, ≥11 μm, ≥12 μm, ≥13 μm, ≥14 μm, or greater. In some embodiments, the thickness of the secondary coating 53 may be less than or equal to (i.e., ≤) 15 μm, ≤14 μm, ≤13 μm, ≤12 μm, ≤11 μm, ≤10 μm, ≤9 μm, ≤8 μm, ≤7 μm, ≤6 μm, ≤5 μm, or less.

### Polymer Coating (e.g., Primary Coating and Secondary Coating Combined) Thickness

In some embodiments, the thickness of the polymer coating 51, or the combined thickness of the primary coating 52 and the secondary coating 53 in some embodiments, may be greater than or equal to (i.e., ≥) 5 μm and less than or equal to (i.e., ≤) 30 μm—including all sub-ranges or values therebetween. For example, the thickness of the polymer coating 51, or the combined thickness of the primary coating 52 and the secondary coating 53 in some embodiments, may be ≥5 μm and ≤30 μm, ≥5 μm and ≤25 μm, ≥5 μm and ≤20 μm, ≥5 μm and ≤15 μm, ≥5 μm and ≤10 μm, ≥10 μm and ≤30 μm, ≥10 μm and ≤25 μm, ≥10 μm and ≤20 μm, ≥10 μm and ≤15 μm, ≥15 μm and ≤30 μm, ≥15 μm and ≤25 μm, ≥15 μm and ≤20 μm, ≥20 μm and ≤30 μm, ≥20 μm and ≤25 μm, or ≥25 μm and ≤30 μm. In some embodiments, the thickness of the polymer coating 51, or the combined thickness of the primary coating 52 and the secondary coating 53 in some instances, may be greater than or equal to (i.e., ≥) 5 μm, ≥7 μm, ≥9 μm, ≥11 μm, ≥13 μm, ≥15 μm, ≥17 μm, ≥19 μm, ≥21 μm, ≥23 μm, ≥25 μm, ≥27 μm, ≥29 μm, or greater. In some embodiments, the thickness of the polymer coating 51, or the combined thickness of the primary coating 52 and the secondary coating 53 in some instances, may be less than or equal to (i.e., ≤) 30 μm, ≤28 μm, ≤26 μm, ≤24 μm, ≤22 μm, ≤20 μm, ≤18 μm, ≤16 μm, ≤14 μm, ≤12 μm, ≤10 μm, ≤8 μm, ≤6 μm, or less.

### Combined Thickness of Metal Coating and Adjacent Primary or Secondary Coating

In some embodiments, the combined thickness of the metal coating 56 and one of adjacent polymer coating layers, such as the primary coating 52 or the secondary coating 53, may be greater than or equal to (i.e., ≥) 1.1 μm and less than or equal to (i.e., ≤) 20 μm—including all sub-ranges or values therebetween. For example, in some embodiments (e.g., the embodiments shown in FIGS. 6 and 8), the combined thickness of the metal coating 56 and the adjacent secondary coating 53 may be greater than or equal to (i.e., ≥) 4.1 μm and less than or equal to (i.e., ≤) 20 μm—including all sub-ranges or values therebetween (e.g., ≥4.1 μm and ≤20 μm, ≥4.1 μm and ≤15 μm, ≥4.1 μm and ≤10 μm, ≥4.1 μm and ≤5 μm, ≥5 μm and ≤20 μm, ≥5 μm and ≤15 μm, ≥5 μm and ≤10 μm, ≥10 μm and ≤20 μm, ≥10 μm and ≤15 μm, or ≥15 μm and ≤20 μm). In some embodiments (e.g., the embodiments shown in FIGS. 7 and 8), the combined thickness of the metal coating 56 and the adjacent primary coating 52 may be greater than or equal to (i.e., ≥) 1.1 μm and less than or equal to (i.e., ≤) 20 μm—including all sub-ranges or values therebetween (e.g., ≥1.1 μm and ≤20 μm, ≥1.1 μm and ≤15 μm, ≥1.1 μm and ≤10 μm, ≥1.1 μm and ≤5 μm, ≥5 μm and ≤20 μm, ≥5 μm and ≤15 μm, ≥5 μm and ≤10 μm, ≥10 μm and ≤20 μm, ≥10 μm and ≤15 μm, or ≥15 μm and ≤20 μm).

In some embodiments, due to the improved mechanical properties provided by the metal coating 56, even smaller combined thickness may be achieved. For example, in some embodiments, the combined thickness of the metal coating 56 and one of adjacent polymer coating layers, such as the primary coating 52 or the secondary coating 53, may be less than or equal to (i.e., ≤) 5 μm, ≤4.8 μm, ≤4.6 μm, ≤4.4 μm, ≤4.2 μm, ≤4 μm, ≤3.5 μm, ≤3 μm, ≤2.5 μm, ≤2 μm, ≤1.8 μm, ≤1.6 μm, ≤1.4 μm, ≤1.2 μm, or less.

For example, in some embodiments (e.g., the embodiments shown in FIGS. 6 and 8), the combined thickness of the metal coating 56 and the adjacent secondary coating 53 may be less than or equal to (i.e., ≤) 5 μm, ≤4.9 μm, ≤4.8 μm, ≤4.7 μm, ≤4.6 μm, ≤4.5 μm, ≤4.4 μm, ≤4.3 μm, ≤4.2 μm, or less.

In some embodiments (e.g., the embodiments shown in FIGS. 7 and 8), the combined thickness of the metal coating 56 and the adjacent primary coating 52 may be less than or equal to (i.e., ≤) 5 μm, ≤4.5 μm, ≤4 μm, ≤3.5 μm, ≤3 μm, ≤2.5 μm, ≤2 μm, ≤1.9 μm, ≤1.8 μm, ≤1.7 μm, ≤1.6 μm, ≤1.5 μm, ≤1.4 μm, ≤1.3 μm, ≤1.2 μm, or less.

### Hybrid (e.g., Polymer and Metal Combined) Coating Thickness

In some embodiments, the thickness of the hybrid coating 50, or the combined thickness of the polymer coating 51 and the metal coating 56, may be greater than or equal to (i.e., ≥) 5.1 μm and less than or equal to (i.e., ≤) 35 μm—including all sub-ranges or values therebetween. For example, in some embodiments, the thickness of the hybrid coating 50, or the combined thickness of the polymer coating 51 and the metal coating 56, may be ≥5.1 μm and ≤35 μm, ≥5.1 μm and ≤30 μm, ≥5.1 μm and ≤25 μm, ≥5.1 μm and ≤20 μm, ≥5.1 μm and ≤15 μm, ≥5.1 μm and ≤10 μm, ≥10 μm and ≤35 μm, ≥10 μm and ≤30 μm, ≥10 μm and ≤25 μm, ≥10 μm and ≤20 μm, ≥10 μm and ≤15 μm, ≥15 μm and ≤35 μm, ≥15 μm and ≤30 μm, ≥15 μm and ≤25 μm, ≥15 μm and ≤20 μm, ≥20 μm and ≤35 μm, ≥20 μm and ≤30 μm, ≥20 μm and ≤25 μm, ≥25 μm and ≤35 μm, ≥25 μm and ≤30 μm, ≥30 μm and ≤35 μm. In some embodiments, the thickness of the hybrid coating 50, or the combined thickness of the polymer coating 51 and the metal coating 56, may be greater than or equal to (i.e., ≥) 5.1 μm, ≥6 μm, ≥8 μm, ≥10 μm, ≥12 μm, ≥14 μm, ≥16 μm, ≥18 μm, ≥20 μm, ≥22 μm, ≥24 μm, ≥26 μm, ≥28 μm, ≥30 μm, ≥32 μm, ≥34 μm, or greater. In some embodiments, the thickness of the hybrid coating 50, or the combined the thickness of the polymer coating 51 and the metal coating 56, may be less than or equal to (i.e., ≤) 35 μm, ≤33 μm, ≤31 μm, ≤29 μm, ≤27 μm, ≤25 μm, ≤23 μm, ≤21 μm, ≤19 μm, ≤17 μm, ≤15μm, ≤13 μm, ≤11 μm, ≤9 μm, ≤7 μm, ≤6 μm, or less.

### Single-Layer Polymer Coating

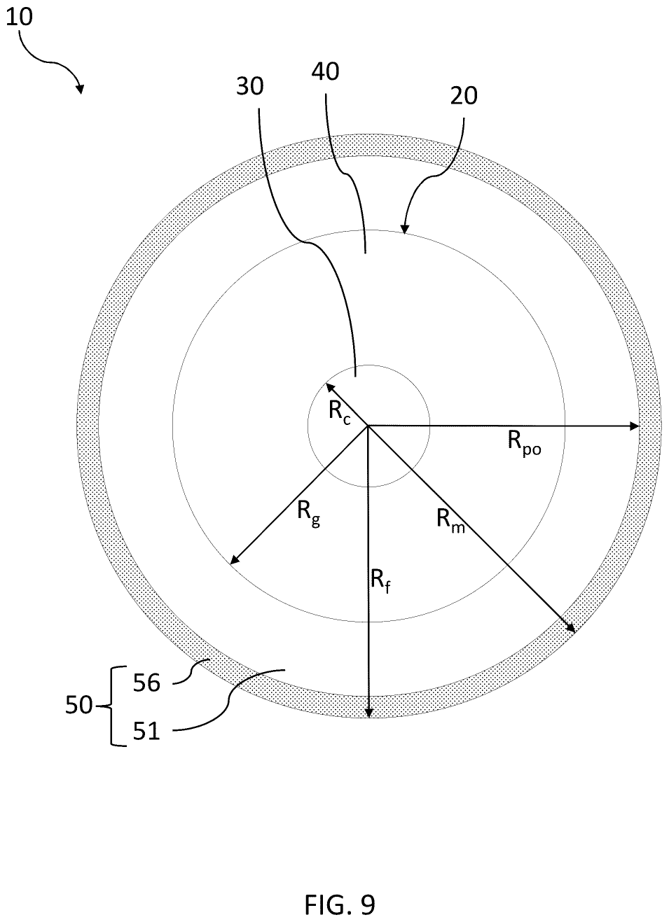

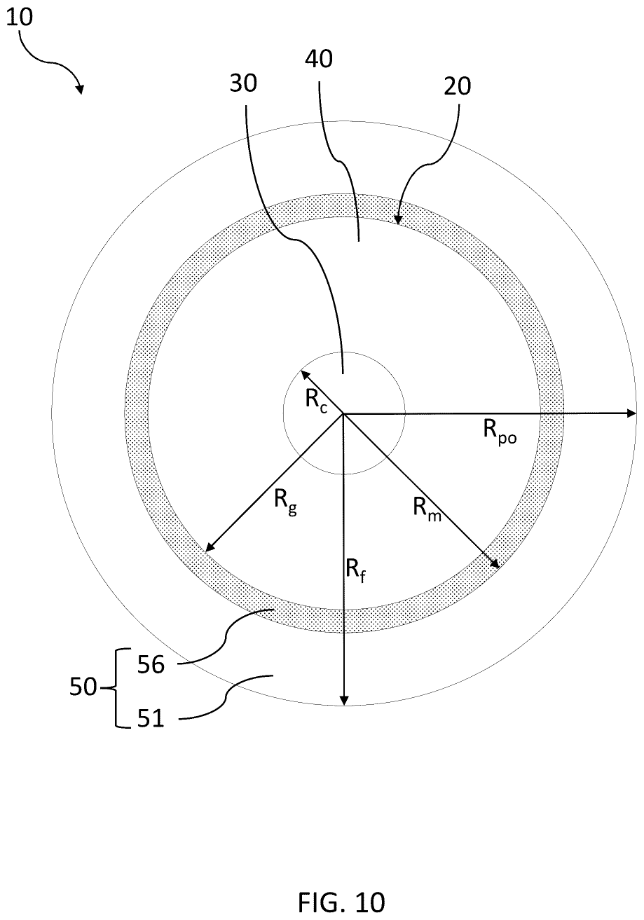

While FIGS. 6, 7, and 8 depict exemplary hybrid coatings 50 each having a dual-layer polymer coating 51 (e.g., a primary coating 52 and a secondary coating 53), the polymer coating 51 of the hybrid coating 50 may include a multi-layer polymer coating having more than two polymer layers in some embodiments, or a single-layer polymer coating in some embodiments, such as shown in FIGS. 9 and 10.

In the embodiments where the hybrid coating 50 may include a single-layer polymer coating 51, the single polymer layer may be disposed between the glass fiber 20 and the metal coating 56, such as shown in FIG. 9, or may be disposed outside the metal coating 56 and form the outermost layer of the hybrid coating 50, such as shown in FIG. 10. In some embodiments, the single-layer polymer coating 51 may include an annular region that may be compositionally and/or structurally homogeneous throughout the entire thickness of the polymer coating 51, which may be defined by the difference between the radius R_{g} of the glass fiber 20 and the outer radius Rₚₒ of the polymer coating 51 in some embodiments such as shown in FIG. 9, or the difference between the outer radius Rₘ of the metal coating 56 and the outer radius Rₚₒ of the polymer coating 51 in some embodiments such as shown in FIG. 10.

In the embodiments where the single-layer polymer coating 51 may be disposed between the glass fiber 20 and the metal coating 56, such as shown in FIG. 9, the outer diameter of the single-layer polymer coating 51, i.e., Dₚₒ=2×Rₚₒ, may be greater than or equal to (i.e., ≥) 115 μm and less than or equal to (i.e., ≤) 150 μm—including all sub-ranges or values therebetween. For example, in some embodiments, the outer diameter of the single-layer polymer coating 51, i.e., Dₚₒ=2×Rₚₒ, may be ≥115 μm and ≤150 μm, ≥115 μm and ≤140 μm, ≥115 μm and ≤130 μm ≥115 and ≤120 μm, ≥125 μm and ≤150 μm, ≥125 μm and ≤140 μm, ≥125 μm and ≤130 μm, ≥135 μm and ≤150 μm, ≥135 μm and 140 μm, or ≥145 μm and ≤150 μm. In some embodiments, the outer diameter of the single-layer polymer coating 51, i.e., Dₚₒ=2×Rₚₒ, may be greater than or equal to (i.e., ≥) 115 μm, ≥120 μm, ≥125 μm, ≥130 μm, ≥135 μm, ≥140 μm, ≥145 μm, or greater. In some embodiments, the outer diameter of the single-layer polymer coating 51, i.e., Dₚₒ=2×Rₚₒ, may be less than or equal to (i.e., ≤) 150 μm, ≤145 μm, ≤140 μm, ≤135 μm, ≤130 μm, ≤125 μm, ≤120 μm, or less. The outer diameter of the metal coating 56, i.e., Dₘ=2×Rₘ, which may also correspond to the diameter of the optical fiber 10, i.e., D_{f}=2×R_{f}, may be greater than or equal to (i.e., ≥) 120 μm and less than or equal to (i.e., ≤) 160 μm—including all sub-ranges or values therebetween. For example, in some embodiments, the outer diameter of the metal coating 56, i.e., Dₘ=2×Rₘ, or the diameter of the optical fiber 10, i.e., D_{f}=2×R_{f}, may be ≥120 μm and ≤160 μm, ≥120 μm and ≤150 μm, ≥120 μm and ≤140 μm, ≥120 μm and ≤130 μm, >130 μm and ≤160 μm, ≥130 μm and ≤150 μm, ≥130 μm and ≤140 μm, ≥140 μm and ≤160 μm, ≥140 μm and ≤150 μm, or ≥150 μm and ≤160 μm. In some embodiments, the outer diameter of the metal coating 56, i.e., Dₘ2=2×Rₘ, or the diameter of the optical fiber 10, i.e., D_{f}=2×R_{f}, may be greater than or equal to (i.e., ≥) 120 μm, ≥125 μm, ≥130 μm, ≥135 μm, ≥140 μm, ≥145 μm, ≥150 μm, ≥155 μm, or greater. In some embodiments, the outer diameter of the metal coating 56, i.e., Dₘ=2×Rₘ, or the diameter of the optical fiber 10, i.e., D_{f}=2×R_{f}, may be less than or equal to (i.e., ≤) 160 μm, ≤155 μm, ≤150 μm, ≤145 μm, ≤140 μm, ≤135 μm, ≤130 μm, ≤125 μm, or less.

In the embodiments where the metal coating 56 may be disposed between the glass fiber 20 and the single-layer polymer coating 51, such as shown in FIG. 10, the outer diameter of the metal coating 56, i.e., Dₘ=2×Rₘ, may be greater than or equal to (i.e., ≥) 115 μm and less than or equal to (i.e., ≤) 125 μm—including all sub-ranges or values therebetween. For example, in some embodiments, the outer diameter of the metal coating 56, i.e., Dₘ=2×Rₘ, may be ≥115 μm and ≤125 μm, ≥115 μm and ≤120 μm, or ≥120 μm and ≤125 μm. In some embodiments, the outer diameter of the metal coating 56, i.e., Dₘ=2×Rₘ, may be greater than or equal to (i.e., ≥) 115 μm, ≥116 μm, ≥117 μm, ≥118 μm, ≥119 μm, ≥120 μm, ≥121 μm, ≥122 μm, ≥123 μm, ≥124 μm, or greater. In some embodiments, the outer diameter of the metal coating 56, i.e., Dₘ=2×Rₘ, may be less than or equal to (i.e., ≤) 125 μm, ≤124 μm, ≤123 μm, ≤122 μm, ≤121 μm, ≤120 μm, ≤119 μm, ≤118 μm, ≤117 μm, ≤116 μm, or less. The outer diameter of the single-layer polymer coating 51, i.e., Dₚₒ=2×Rₚₒ, which may also correspond to the diameter of the optical fiber 10, i.e., D_{f}=2×R_{f}, may be greater than or equal to (i.e., ≥) 120 μm and less than or equal to (i.e., ≤) 160 μm—including all sub-ranges or values therebetween. For example, in some embodiments, the outer diameter of the single-layer polymer coating 51, i.e., Dₚₒ=2×Rₚₒ, or the diameter of the optical fiber 10, i.e., D_{f}≤2×R_{f}, may be ≥120 μm and ≤160 μm, ≥120 μm and ≤150 μm, ≥120 μm and ≤140 μm, ≥120 μm and ≤130 μm, ≥130 μm and ≤160 μm, >130 μm and ≤150 μm, ≥130 μm and ≤140 μm, ≥140 μm and ≤160 μm, ≥140 μm and ≤150 μm, or ≥150 μm and ≤160 μm. For example, in some embodiments, the outer diameter of the single-layer polymer coating 51, i.e., Dₚₒ=2×Rₚₒ, or the diameter of the optical fiber 10, i.e., D_{f}=2×R_{f}, may be greater than or equal to (i.e., ≥) 120 μm, ≥125 μm, ≥130 μm, ≥135 μm, ≥140 μm, ≥145 μm, ≥150 μm, ≥155 μm, or greater. For example, in some embodiments, the outer diameter of the single-layer polymer coating 51, i.e., Dₚₒ=2×Rₚₒ, or the diameter of the optical fiber 10, i.e., D_{f}=2×R_{f}, may be less than or equal to (i.e., ≤) 160 μm, ≤155 μm, ≤150 μm, ≤145 μm, ≤140 μm, ≤135 μm, ≤130 μm, ≤125 μm, or less.

In some embodiments, the single-layer polymer coating 51 may include a material similar to, or the same as, the material forming the secondary coating 53, which may have a relatively high Young's modulus, as will be discussed in more detail below. In some embodiments, the single-layer polymer coating 51 may include a material similar to, or the same as, the material forming the primary coating 53, which may have a relatively low Young's modulus, as will be discussed in more detail below. In some embodiments, the single-layer polymer coating 51 may include a material having a Young's modulus greater than or equal to the Young's modulus of material forming the primary coating 52 and less than or equal to the Young's modulus of the material forming the secondary coating 53.

In some embodiments, the thickness of the single-layer polymer coating 51 may be greater than or equal to (i.e., ≥) 5 μm and less than or equal to (i.e., ≤) 20 μm—including all sub-ranges or values therebetween. For example, in some embodiments, the thickness of the single-layer polymer coating 51 may be ≥5 μm and ≤20 μm, ≥5 μm and ≤15 μm, ≥5 μm and ≤10 μm, ≥10 μm and ≤20 μm, ≥10 μm and ≤15 μm, or ≥15 μm and ≤20 μm. In some embodiments, the thickness of the single-layer polymer coating 51 may be greater than or equal to (i.e., ≥) 5 μm, ≥6 μm, ≥7 μm, ≥8 μm, ≥9 μm, ≥10 μm, ≥11 μm, ≥12 μm, ≥13 μm, ≥14 μm, ≥15 μm, ≥16 μm, ≥17 μm, ≥18 μm, ≥19 μm, or greater. In some embodiments, the thickness of the single-layer polymer coating 51 may be less than or equal to (i.e., ≤) 20 μm, ≤19 μm, ≤18 μm, ≤17 μm, ≤16 μm, ≤15 μm, ≤14 μm, ≤13 μm, ≤12 μm, ≤11 μm, ≤10 μm, ≤9 μm, ≤8 μm, ≤7 μm, ≤6 μm, or less.

In the embodiments where a single-layer polymer coating 51 may be employed, the thickness of the metal coating 56 may be the same or similar to the thickness of the metal coating 51 utilized in the various other embodiments described above. For example, the thickness of the metal coating 56 may be greater than or equal to (i.e., ≥) 0.1 μm and less than or equal to (i.e., ≤) 5 μm—including all sub-ranges or values therebetween. In some embodiments, the thickness of the metal coating 56 may be greater than or equal to (i.e., ≥) 0.1 μm, ≥0.5 μm, ≥1.0 μm, ≥1.5 μm, ≥2.0 μm, ≥2.5 μm, ≥3.0 μm, ≥3.5 μm, ≥4.0 μm, ≥4.5 μm, or greater. In some embodiments, the thickness of the metal coating 56 may be less than or equal to (i.e., ≤) 5 μm, ≤4.5 μm, ≤4.0 μm, ≤3.5 μm, ≤3.0 μm, ≤2.5 μm, ≤2.0 μm, ≤1.5 μm, ≤1.0 μm, ≤0.5 μm, or less.

The combined thickness of the metal coating 56 and the single-layer polymer coating 51 may be greater than or equal to (i.e., ≥) 5.1 μm and less than or equal to (i.e., ≤) 25 μm—including all sub-ranges or values therebetween. For example, in some embodiments, the combined thickness of the metal coating 56 and the single-layer polymer coating 51 may be ≥5.1 μm and ≤25 μm, ≥5.1 μm and ≤20 μm, ≥5.1 μm and ≤15 μm, ≥5.1 μm and ≤10 μm, ≥10 μm and ≤25 μm, ≥10 μm and ≤20 μm, ≥10 μm and ≤15 μm, ≥15 μm and ≤25 μm, ≥15 μm and ≤20 μm, or ≥20 μm and ≤25 μm. In some embodiments, the combined thickness of the metal coating 56 and the single-layer polymer coating 51 may be greater than or equal to (i.e., ≥) 5.1 μm, ≥7 μm, ≥9 μm, ≥11 μm, ≥13 μm, ≥15 μm, ≥17 μm, ≥19 μm, ≥21 μm, ≥23 μm, or greater. In some embodiments, the combined thickness of the metal coating 56 and the single-layer polymer coating 51 may be less than or equal to (i.e., ≤) 25 μm, ≤24 μm, ≤22 μm, ≤20 μm, ≤18 μm, ≤16 μm, ≤14 μm, ≤12 μm, ≤10 μm, ≤8 μm, ≤6 μm, or less.

### Homogenous Coating

In the various embodiments described herein, one or more or each of the primary coating 52, the secondary coating 53, the metal coating 56, and/or the single-layer polymer coating 51 may include an annular region that may be compositionally and/or structurally homogeneous throughout the entirety of the respective thickness thereof. In some embodiments, the primary coating 52 may include an annular region that may be compositionally and/or structurally homogeneous throughout the entirety of the thickness of the primary coating 52. In some embodiments, the secondary coating 53 may include an annular region that may be compositionally and/or structurally homogeneous throughout the entirety of the thickness of the secondary coating 53. In some embodiments, the metal coating 56 may include an annular region that may be compositionally and/or structurally homogeneous throughout the entirety of the thickness of the metal coating 56. In some embodiments, the single-layer polymer coating 51 may include an annular region that may be compositionally and/or structurally homogeneous throughout the entirety of the thickness of the single-layer polymer coating 51.

In some embodiments, the metal coating 56 may form a continuous, uniform coating about the longitudinal axis or centerline axis of the optical fiber 10 and around the entire circumference of the layer surrounded by and directly contacting the metal coating 56, such as shown in the various cross-sectional views of FIGS. 6-10. Although not shown in the cross-sectional views, the metal coating 56 may be disposed or formed along an entirety or a majority (e.g., ≥50%, ≥60%, ≥70%, ≥80%, ≥90%, ≥95%, or ≥99%) of the length of the optical fiber 10 in some embodiments.

### Polymer Coating Materials

In some embodiments, the primary coating 52 and/or the secondary coating 53 may include acrylate, polyimide, polyetherimide, or any other suitable polymer materials. To promote adhesion between the polymer coating 51 and the adjacent glass cladding 40 and/or the adjacent the metal coating 56, additives, such silanes, organotitanates, zirconates, and the like, may be added into the formulation of the primary coating 52 and/or the secondary coating 53. Additional exemplary materials and/or formulations that may be used for the primary coating 52 and/or secondary coating 53 are described in U.S. Pat. Nos. 9,057,817 and 11,782,207, the contents of which are incorporated by reference herein in their entireties.

As mentioned above, the secondary coating 53 in the various embodiments described herein may have a Young's modulus greater than the Young's modulus of the primary coating 52.

In some embodiments, the Young's modulus of the primary coating 52 may be greater than or equal to (i.e., ≥) 0.1 MPa and less than or equal to (i.e., ≤) 5 Mpa—including all—including all sub-ranges or values therebetween-ranges or values therebetween. For example, in some embodiments, the Young's modulus of the cured primary coating 52 may be ≥0.1 Mpa and ≤5 Mpa, ≥0.1 Mpa and ≤4 Mpa, ≥0.1 Mpa and ≤3 Mpa, ≥0.1 Mpa and ≤2 Mpa, ≥0.1 Mpa and ≤1 Mpa, ≥0.1 Mpa and ≤0.5 Mpa, ≥0.5 Mpa and ≤5 Mpa, ≥0.5 Mpa and ≤4 Mpa, ≥0.5 Mpa and ≤3 Mpa, ≥0.5 Mpa and ≤2 Mpa, ≥0.5 Mpa and ≤1 Mpa, ≥1 Mpa and ≤5 Mpa, ≥1 Mpa and ≤4 Mpa, ≥1 Mpa and ≤3 Mpa, ≥1 Mpa and ≤2 Mpa, ≥2 Mpa and ≤5 Mpa, ≥2 Mpa and ≤4 Mpa, ≥2 Mpa and ≤3 Mpa, ≥3 Mpa and ≤5 Mpa, ≥3 Mpa and ≤4 Mpa, or ≥4 Mpa and ≤5 Mpa.

In some embodiments, the Young's modulus of the primary coating 52 may be less than or equal to (i.e., ≤) 5 Mpa, ≤4.5 Mpa, ≤4 Mpa, ≤3.5 Mpa, ≤3 Mpa, ≤2.5 Mpa, ≤2 Mpa, ≤1.5 Mpa, ≤1 Mpa, ≤0.5 Mpa, or less. In some embodiments, the Young's modulus of the primary coating 52 may be greater than or equal to (i.e., ≥) 0.1 Mpa, ≥0.5 Mpa, ≥1 Mpa, ≥1.5 Mpa, ≥2 Mpa, ≥2.5 Mpa, ≥3 Mpa, ≥3.5 Mpa, ≥4 Mpa, ≥4.5 Mpa, or greater.

In some embodiments, the Young's modulus of the secondary coating 53 may be greater than or equal to (i.e., ≥) 0.5 GPa and Young's modulus of cured secondary coating is less than or equal to (i.e., ≤) 10 GPa—including all—including all sub-ranges or values therebetween-ranges or values therebetween. For example, in some embodiments, the Young's modulus of the secondary coating 53 may be ≥0.5 GPa and ≤10 GPa, ≥0.5 GPa and ≤8 GPa, ≥0.5 GPa and ≤5 GPa, ≥0.5 GPa and ≤4 GPa, ≥0.5 GPa and ≤2 GPa, ≥0.5 GPa and ≤1 GPa, ≥1 GPa and ≤10 GPa, ≥1 GPa and ≤8 GPa, ≥1 GPa and ≤5 GPa, ≥1 GPa and ≤4 GPa, ≥1 GPa and ≤2 GPa, ≥2 GPa and ≤10 GPa, ≥2 GPa and ≤8 GPa, ≥2 GPa and ≤5 GPa, ≥2 GPa and ≤4 GPa, ≥4 GPa and ≤10 GPa, ≥4 GPa and ≤8 GPa, ≥4 GPa and ≤5 GPa, ≥5 GPa and ≤10 GPa, ≥5 GPa and ≤8 GPa, or ≥8 GPa and ≤10 GPa.

In some embodiments, the Young's modulus of the secondary coating 53 may be greater than or equal to (i.e., ≥) 0.5 GPa, ≥1 GPa, ≥1.5 GPa, ≥2 GPa, ≥2.5 GPa, ≥3 GPa, ≥3.5 GPa, ≥4 GPa, ≥4.5 GPa, ≥5 GPa, ≥5.5 GPa, ≥6 GPa, ≥6.5 GPa, ≥7 GPa, ≥7.5 GPa, ≥8 GPa, ≥8.5 GPa, ≥9 GPa, ≥9.5 GPa, or greater. In some embodiments, the Young's modulus of the secondary coating 53 may be less than or equal to (i.e., ≤) 10 GPa, ≤9.5 GPa, ≤9 GPa, ≤8.5 GPa, ≤8 GPa, ≤7.5 GPa, ≤7 GPa, ≤6.5 GPa, ≤6 GPa, ≤5.5 GPa, ≤5 GPa, ≤4.5 GPa, ≤4 GPa, ≤3.5 GPa, ≤3 GPa, ≤2.5 GPa, ≤2 GPa, ≤1.5 GPa, ≤1 GPa, or less.

### Measuring Young's Modulus

Young's modulus of a low-modulus coating, such as the primary coating 52, can be measured on films formed by curing the coating compositions for forming the low-modulus coating. Wet films of the coating composition are cast on silicone release paper with the aid of a draw-down box having a gap thickness of about 0.005″. The wet films are cured with a UV dose of 1.2 J/cm² (measured over a wavelength range of 225-424 nm by a Light Bug model IL490 from International Light) by a Fusion Systems UV curing apparatus with a 600 W/in D-bulb (50% Power and approximately 12 ft/min belt speed) to yield cured coatings in film form. Cured film thickness are between about 0.0030″ and 0.0035″. The films are aged (23° C., 50% relative humidity) for at least 16 hours prior to testing. Film samples are cut to dimensions of 12.5 cm×13 mm using a cutting template and a scalpel. Young's modulus, tensile strength at break, and % elongation (% strain at break) are measured at room temperature (approximately 20° C.) on the film samples using an MTS Sintech tensile test instrument following procedures set forth in ASTM Standard D882-97. Young's modulus is defined as the steepest slope of the beginning of the stress-strain curve. Tensile toughness is defined as the integrated area under the stress-strain curve. Films are tested at an elongation rate of 2.5 cm/min with the initial gauge length of 5.1 cm.

Young's modulus, along with tensile strength at break, yield strength, and elongation at yield, of a high-modulus coating, such as the secondary coating 53, can be measured as follows. The curable high-modulus coating composition for forming the high-modulus coating is cured and configured in the form of cured rod samples for measurement of Young's modulus. The cured rods are prepared by injecting the curable high-modulus coating composition into Teflon® tubing having an inner diameter of about 0.025″. The rod samples are cured using a Fusion D bulb at a dose of about 2.4 J/cm² (measured over a wavelength range of 225-424 nm by a Light Bug model IL390 from International Light). After curing, the Teflon® tubing is stripped away to provide a cured rod sample of the high-modulus coating composition. The cured rods are allowed to condition for 18-24 hours at 23° C. and 50% relative humidity before testing. Young's modulus, tensile strength at break, yield strength, and elongation at yield are measured using a Sintech MTS Tensile Tester on defect-free rod samples with a gauge length of 51 mm, and a test speed of 250 mm/min. Tensile properties are measured according to ASTM Standard D882-97. The properties are determined as an average of at least five samples, with defective samples being excluded from the average.

### Metal Coating Materials

In some embodiments, the metal coating 56 may include Al, Sn, Au, Ta, Ni, Cr, Ti, Ag, Cu, Zr, stainless steel, or their alloys, or any other suitable metals and/or alloys thereof.

### Mechanical and Fiber Density Improvement

The various hybrid coatings described herein may allow a much smaller overall coating thickness to be utilized to increase fiber density while providing sufficient mechanical protection to the fiber without compromising the microbending performance. Specifically, the polymer coating of the hybrid coating described herein may allow for excellent microbending performance to be achieved, while the thin metal coating may provide enhance mechanical protection, such as improved puncture resistance, for the optical fiber.

In some embodiments, the optical fiber may demonstrate a puncture resistance greater than or equal to (i.e., ≥) 20 g and less than or equal to (i.e., ≤) 100 g—including all sub-ranges or values therebetween. For example, in some embodiments, the optical fiber may demonstrate a puncture resistance ≥20 g and ≤100 g, ≥20 g and ≤80 g, ≥20 g and ≤60 g, ≥20 g and ≤40 g, ≥40 g and ≤100 g, ≥40 g and ≤80 g, ≥40 g and ≤60 g, ≥60 g and ≤100 g, ≥60 g and ≤80 g, or ≥80 g and ≤100 g. In some embodiments, the optical fiber may demonstrate a puncture resistance greater than or equal to (i.e., ≥) 20 g, ≥25 g, ≥30 g, ≥35 g, ≥40 g, ≥45 g, ≥50 g, ≥55 g, ≥60 g, ≥65 g, ≥70 g, ≥75 g, ≥80 g, ≥85 g, ≥90 g, ≥95 g, or greater.

The puncture resistance test can be performed by modifying the indentation method as described in G. S. Glaesemann, D. A. Clark, “Quantifying the Puncture Resistance of Optical Fiber Coatings,” Proc. 52nd IWCS, pp.237-245, 2003, which establishes procedures for testing the puncture resistance of dual-layer polymer coatings. In that method, as a diamond wedge indenter with an included angle of 75° is driven into the coated fiber, a load drop is observed when the indenter ruptures the high-modulus secondary coating and reaches the low-modulus primary coating. For the metal and polymer hybrid coatings described herein, a load drop may not be observed at least in part due to the presence of the metal coating. Accordingly, a modified method has been developed by driving the diamond wedge indenter into the coated fiber until the indenter hits the glass cladding through the hybrid coating, upon which a flaw is created in the glass by the indenter in a manner similar to how a fiber cleaver creates a flaw in the glass, causing the fiber to break upon contact with by the indenter. The load is applied in 5-g force increments. The corresponding force at which the fiber breaks apart is recorded as the puncture resistance of the metal and polymer hybrid coating.

In some embodiments, an optical fiber ribbon or an optical fiber cable incorporating two or more of the optical fibers described herein may achieve a fiber density increase by a factor of 2, 3, 4, 5, 6, or more relative to the standard 250 μm coated fibers.

### Fiber Manufacturing Process

The optical fibers described herein may be formed from a continuous optical fiber manufacturing process, during which a glass fiber may be drawn from a heated preform and sized to a target diameter. The glass fiber may then be cooled and directed to a coating system, which may be configured to apply the polymer coating (single-layer or multi-layer) to the glass fiber. For example, in embodiments where the optical fiber may employ a multi-layer (e.g., dual-layer) polymer coating, the coating system may first apply a liquid low-modulus primary coating composition to the glass fiber. After application of the liquid low-modulus primary coating composition to the glass fiber, in some embodiments (such as in a wet-on-dry process), the liquid low-modulus primary coating composition may be cured to form a solidified low-modulus primary coating, a liquid high-modulus secondary coating composition may then be applied to the cured low-modulus primary coating, and the liquid high-modulus coating composition may then be cured to form a solidified high-modulus secondary coating. In some embodiments (such as in a wet-on-wet process), after application of the liquid low-modulus primary coating composition to the glass fiber, the liquid high-modulus secondary coating composition may be applied to the liquid low-modulus primary coating composition, and both liquid coating compositions may be cured simultaneously to provide solidified low-modulus primary coating and solidified high-modulus secondary coating. In some embodiments, after forming the primary and secondary coatings, the fiber may exit the coating system, and the fiber may be collected by, e.g., winding the fiber on a spool. In embodiments where the optical fiber may employ a single-layer polymer coating, only one application of a liquid coating composition may be carried out, and the applied liquid coating composition may be cured to form the solidified single-layer polymer coating prior to exiting the coating system.

An offline process, such as physical vapor deposition, electroplating, electroless plating, or any other suitable application method or technique, may then be utilized to apply the metal coating over the polymer coating. In some embodiments, a combination of different processes may be employed for application of the metal coating. For example, in some embodiments, physical vapor deposition may be utilized for deposition of a uniform, thin metal coating directly on the polymer coating. In some embodiments, electroplating and/or electroless plating may be utilized for further deposition to increase the thickness of the metal coating.

In some embodiments, such as in the process described above, the polymer coating application and the fiber draw process may be integrated as a continuous fiber manufacturing process, while the metal coating may be applied in a separate offline process. In some embodiments, the fiber draw process and the application of both the polymer and metal coatings may all be integrated into a common continuous manufacturing process. The metal coating application may be applied prior to or after the application of the polymer coating in some embodiments, or may be applied between applications of the primary coating and the secondary coating in embodiments where the metal coating may be disposed between the primary and secondary coatings. In some embodiments, both the metal coating and the polymer coating may be applied in offline processes, separate from the fiber draw process.

### Exemplary Optical Fibers with Hybrid Coating

Provided below are exemplary embodiments of the optical fibers disclosed herein. The below examples are intended to be exemplary and are not intended to limit the scope of the disclosure.

An exemplary optical fiber having a hybrid coating of one layer of polymer coating and one layer of metal coating was produced. The core region of the optical fiber was doped with Ge with a relative refractive index of 0.34%, and the core diameter was about 9 μm. The cladding region was pure silica. The fiber had a glass diameter of about 113 μm, and the glass fiber was coated with a single-layer high-modulus (1.5 GPa) polymer coating having an outer diameter of about 124.2 μm. The fiber was then coated with nickel (Ni) using a physical vapor deposition (PVD) process. Two segments (Fiber Segment 1 and Fiber Segment 2) of the produced fiber were taken for measurements.

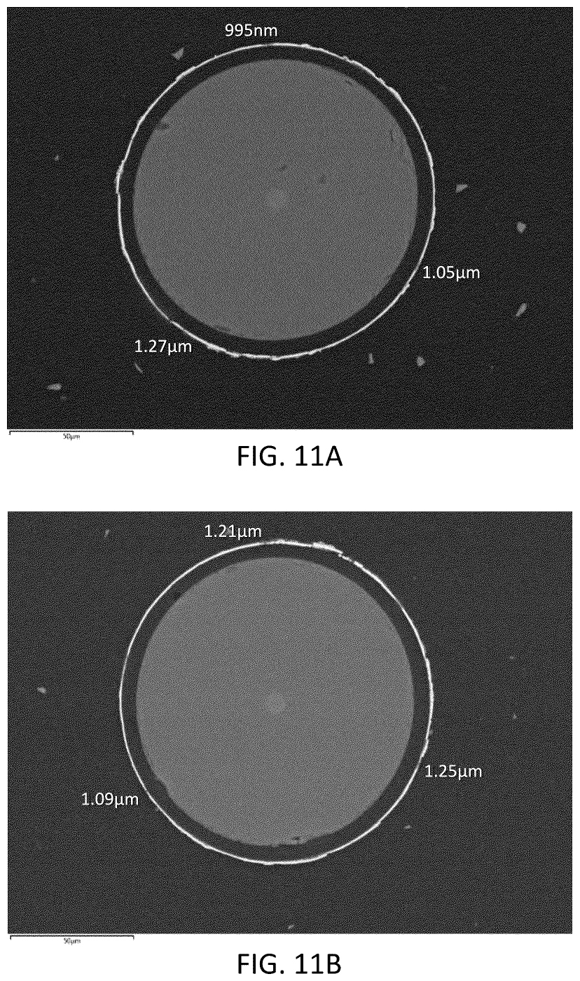

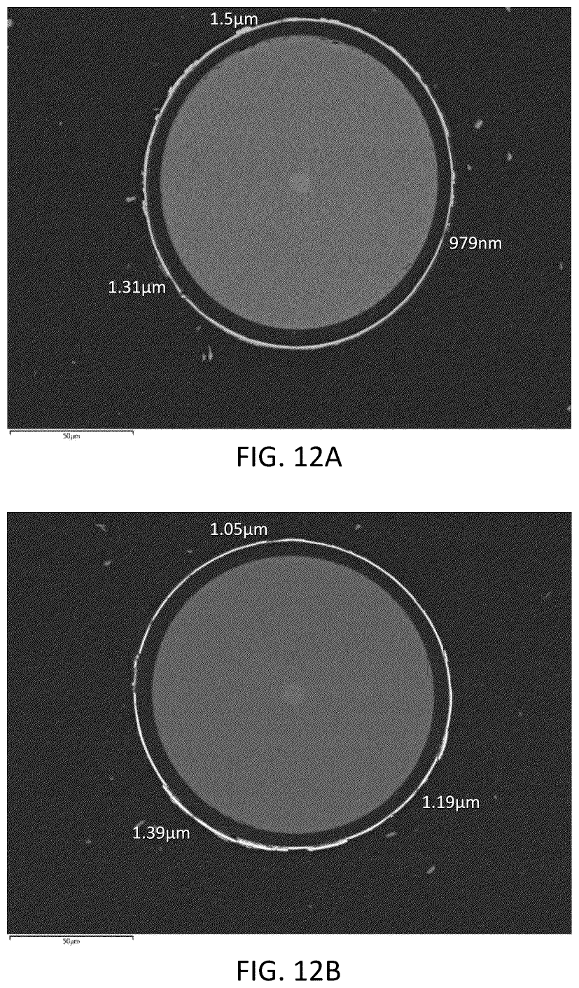

FIGS. 11A and 11B are images of the opposite end faces of Fiber Segment 1, and FIGS. 12A and 12B are images of the opposite end faces of Fiber Segment 2. Three measurements of the thickness of the Ni metal coating were taken at three locations at each end face as shown in FIGS. 11A, 11B, 12A, and 12B, and summarized in Table 2 below. For Fiber Segment 1, the average thickness from all locations is 1.144±0.114 μm. For Fiber Segment 2, the average thickness from all locations is 1.237±0.201 μm.

TABLE 2

| Fiber | | | Ni Coating | | |
|---|---|---|---|---|---|
| Segment | | Measurement | Thickness | Average | Standard |
| No. | End | No. | (μm) | (μm) | Deviation |
| 1 | A | 1 | 0.995 | 1.144 | 0.114 |
| | | 2 | 1.050 | | |
| | | 3 | 1.270 | | |
| | B | 1 | 1.210 | | |
| | | 2 | 1.250 | | |
| | | 3 | 1.090 | | |
| 2 | A | 1 | 1.500 | 1.237 | 0.201 |
| | | 2 | 0.979 | | |
| | | 3 | 1.310 | | |
| | B | 1 | 1.050 | | |
| | | 2 | 1.190 | | |
| | | 3 | 1.390 | | |

Puncture Resistance of the Hybrid Coating

To demonstrate the improvement in fiber mechanical protection provided by the hybrid coating, fiber puncture resistance tests were performed on Fiber Segment 1, Fiber Segment 2, and a comparative fiber in accordance with the puncture resistance test procedures described above. The comparative fiber did not include a metal coating but otherwise had the same fiber structure as the fiber from which Fiber Segment 1 and Fiber Segment 2 were obtained. Fiber 1 and Fiber 2 with the metal and polymer hybrid coating demonstrated improved puncture resistance. Specifically, without the metal layer, the puncture force was about 40 g. With the metal layer, the puncture force increased to about 60 g to 70 g, corresponding to an improvement of about 50% to 70%.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. An optical fiber, comprising:
a glass fiber comprising:
a core region; and
a cladding region surrounding the core region; and
a hybrid coating surrounding the cladding region, the hybrid coating comprising:
a polymer coating, the polymer coating comprising:
a primary coating; and
a secondary coating surrounding the primary coating;
wherein a Young's modulus of the secondary coating is greater than a Young's modulus of the primary coating; and
a metal coating.

2. The optical fiber according to claim 1, wherein the metal coating is disposed between the primary coating and the cladding region.

3. The optical fiber according to claim 1, wherein the metal coating directly contacts the cladding region.

4. The optical fiber according to claim 1, wherein an outer diameter of the metal coating is greater than or equal to 30.2 μm and less than or equal to 130 μm.

5. The optical fiber according to claim 1, wherein the primary coating and the secondary coating satisfy at least one of the following:
an outer diameter of the primary coating is greater than or equal to 32 μm and less than or equal to 165 μm;
an outer diameter of the secondary coating is greater than or equal to 40 μm and less than or equal to 170 μm;
a thickness of the primary coating is greater than or equal to 1 μm and less than or equal to 15 μm;
a thickness of the secondary coating is greater than or equal to 4 μm and less than or equal to 15 μm; or
a combined thickness of the primary coating and the secondary coating is greater than or equal to 5 μm and less than or equal to 30 μm.

6. The optical fiber according to claim 1, wherein the metal coating is disposed between the primary coating and the secondary coating.

7. The optical fiber according to claim 1, wherein the metal coating surrounds the secondary coating.

8. The optical fiber according to claim 7, wherein the primary coating and the secondary coating satisfy at least one of the following:
an outer diameter of the primary coating is greater than or equal to 32 μm and less than or equal to 145 μm;
an outer diameter of the primary coating is greater than or equal to 40 μm and less than or equal to 165 μm; or an outer diameter of the secondary coating is greater than or equal to 40.2 μm and less than or equal to 170 μm.

9. The optical fiber according to claim 1, wherein the primary coating, the secondary coating, and the metal coating satisfy at least one of the following:
a thickness of the primary coating is less than 5 μm;
a thickness of the secondary coating is less than 5 μm;
a thickness of the metal coating is greater than or equal to 0.1 μm and less than or equal to 5 μm;
a combined thickness of the secondary coating and the metal coating is greater than or equal to 4.1 μm and less than or equal to 20 μm;
the combined thickness of the secondary coating and the metal coating is less than or equal to 5 μm;
a combined thickness of the primary coating and the metal coating is greater than or equal to 1.1 μm less than or equal to 20 μm; or
the combined thickness of the primary coating and the metal coating is less than or equal to 5 μm.

10. The optical fiber according to claim 1, wherein a puncture resistance of the optical fiber is greater than or equal to 20 g and less than or equal to 100 g.

11. The optical fiber according to claim 1, wherein a diameter of the optical fiber is less than or equal to 170 μm.

12. The optical fiber according to claim 1, wherein the metal coating comprises at least one of stainless steel, Al, Sn, Au, Ta, Ni, Cr, Ti, Ag, Cu, Zr, or an alloy thereof.

13. The optical fiber according to claim 1, wherein the optical fiber exhibits an attenuation less than or equal to 0.36 dB/km at a wavelength of 1310 nm and/or an attenuation less than or equal to 0.24 dB/km at a wavelength of 1550 nm.

14. The optical fiber according to claim 1, wherein the optical fiber is integrated in at least one of a high density optical interconnect, an optical fiber ribbon, or an optical fiber cable.

15. An optical fiber, comprising:
a glass fiber comprising:
a core region; and
a cladding region surrounding the core region; and
a hybrid coating surrounding the cladding region, the hybrid coating comprising:
a metal coating; and
a polymer coating;
wherein the metal coating is disposed between the polymer coating and the cladding region.

16. The optical fiber according to claim 15, wherein the metal coating directly contacts the cladding region.

17. The optical fiber according to claim 15, wherein the polymer coating comprises at least one of a primary coating or a secondary coating, and wherein a Young's modulus of the primary coating is less than a Young's modulus of the secondary coating.

18. The optical fiber according to claim 17, wherein the polymer coating comprises only one of the primary coating or the secondary coating.

19. The optical fiber according to claim 15, wherein the polymer coating and the metal coating satisfy at least one of the following:
a thickness of the metal coating is greater than or equal to 0.1 μm and less than or equal to 5 μm;
a thickness of the polymer coating is greater than or equal to 5 μm and less than or equal to 30 μm, or greater than or equal to 5 μm and less than or equal to 20 μm; or
a combined thickness of the metal coating and the polymer coating is greater than or equal to 5.1 μm and less than or equal to 35 μm, or greater than or equal to 5.1 μm and less than or equal to 25 μm.

20. The optical fiber according to claim 15, wherein a puncture resistance of the optical fiber is greater than or equal to 20 g and less than or equal to 100 g.
